(19) United States
(12) Patent Application Publication
(10) Pub. No.: US 2026/0192586 A1
(43) Pub. Date: Jul. 9, 2026

(54) Printhead

(71) Applicant: Videojet Technologies Inc., Wood Dale, IL (US)

(72) Inventors: Robert Smith, Cambridgeshire (GB); Steven John Buckby, Nottingham (GB); Matthew William Stephen Burrows, Cambridge (GB); Stuart Edward Watson, Cambridge (GB); Christian Valentine Burton, Cambridge (GB)

(21) Appl. No.: 19/133,962

(22) PCT Filed: Dec. 13, 2023
(86) PCT No.: PCT/GB2023/053221

§ 371 Date: May 29, 2025

(30) Foreign Application Priority Data
Dec. 19, 2022 (GB) 2219181.1
Dec. 19, 2022 (GB) 2219186.0

(51) Int. Cl. B41J 25/34; B41J 2/02; B41J 2/085; B41J 2/09; B41J 2/185

(52) U.S. Cl. CPC B41J 25/34; B41J 2/02; B41J 2/085; B41J 2/09; B41J 2/185; B41J 2002/022; B41J 2002/1853; B41J 2202/14

(57) ABSTRACT

There is provided a continuous inkjet printer for printing onto an external substrate that moves past the printer. The printer comprising a printhead. The printhead comprising: a droplet generator configured to generate and eject a stream of ink droplets for printing; at least one electrode configured to steer the stream of ink droplets; and a gutter configured to receive droplets of ink which are not used for printing. The printer further comprising an ink system configured to store ink and supplying ink to the printhead. The printhead is releasably connectable to the ink system by a printhead connection interface, the printhead connection interface comprising a plurality of fluid connectors, a plurality of electrical connectors; and the printer is configured to permit the printhead to be removed from printer, and for an alternative printhead to be connected to the printer, and for printing operations to commence within a period of around 2 minutes.

The present invention relates to a continuous inkjet (CIJ) printer, and associated methods of using and controlling the same.

In inkjet printing systems, the print is made up of individual droplets of ink generated at a nozzle and propelled towards a substrate. There are two principal systems: droplet on demand, where ink droplets for printing are generated as and when required; and continuous inkjet (CIJ) printing, in which droplets are continuously produced and only selected ones are directed towards the substrate, the others being recirculated to an ink system.

CIJ printers supply pressurised ink to a print head droplet generator where a continuous stream of ink emanating from a nozzle is broken up into individual regular droplets by, for example, an oscillating piezoelectric element. The droplets are directed past a charge electrode, where they are selectively and separately given a predetermined charge, before passing through a transverse electric field provided across a pair of deflection plates, the pair comprising a high voltage (or extra high tension (EHT)) plate and a zero or negative voltage plate (the ‘ground’ plate). Each charged droplet is deflected by the field by an amount that is dependent on its charge magnitude before impinging on the substrate, whereas the uncharged droplets proceed without deflection and are collected at a gutter from where they are recirculated to the ink system. The charged droplets bypass the gutter and hit the substrate at a position determined by the charge on the droplet and the position of the substrate relative to the print head. Typically, the substrate is moved relative to the print head in one direction and the droplets are deflected in a direction generally perpendicular thereto, although the deflection plates may be oriented at an inclination to the perpendicular to compensate for the speed of the substrate (the movement of the substrate relative to the print head between droplets arriving means that a line of droplets would otherwise not quite extend perpendicularly to the direction of movement of the substrate). The various components of the print head are typically contained within a cover tube or print head casing.

In CIJ printing, a character is printed from a matrix comprising a regular array of potential droplet positions. Each matrix comprises a plurality of columns (strokes), each being defined by a line comprising a plurality of potential droplet positions (e.g. seven) determined by the charge applied to the droplets. Thus, each usable droplet is charged according to its intended position in the stroke. If a particular droplet is not to be used then the droplet is not charged and it is captured at the gutter for recirculation. This cycle repeats for all strokes in a matrix and then starts again for the next character matrix.

Ink is delivered under pressure to the print head by an ink system that is generally housed within a sealed compartment of a cabinet that includes a separate compartment for control circuitry and a user interface panel. The ink system includes a main pump that draws the ink from a reservoir or tank (often referred to as a mixer tank) via a filter and delivers it under pressure to the print head. As ink is consumed, the reservoir is refilled as necessary from a replaceable ink cartridge that is releasably connected to the reservoir by a supply conduit. The ink is fed from the reservoir via a flexible delivery conduit to the print head. The unused ink droplets captured by the gutter are recirculated to the reservoir via a return conduit by a pump. The flow of ink in each of the conduits is generally controlled by solenoid valves and/or other like components.

As the ink circulates through the system, there is a tendency for it to thicken because of solvent evaporation, particularly in relation to the recirculated ink that has been exposed to air in its passage between the nozzle and the gutter. In order to compensate for this, “make-up” solvent is added to the ink as required from a replaceable solvent cartridge to maintain the ink viscosity within desired limits. The ink and solvent cartridges are filled with a predetermined quantity of fluid and generally releasably connected to the reservoir, or mixer tank, of the ink supply system so that the reservoir can be intermittently topped-up by drawing ink and/or solvent from the cartridges as required.

CIJ printers generally operate in high throughput environments for which the printers, and inks, need to be able to keep up with high production line speeds, fast drying time requirements and virtually non-stop production. This generally requires larger containers for storing and holding the ink and solvent (e.g. cartridges and mixer tank), which take up space within the system, and results in high volumes of ink circulating through the printer. For example, the main pump of the ink supply system may typically circulate around 0.5 litres/min of ink, with only around 2-3 millilitres/min of ink being ejected from the print head for printing during this time. The main pump is therefore generally fairly large and space consuming, and operation of the pump generally results in significant heat generation. To manage this, the printer generally requires fans to prevent the printer and/or ink supply system from overheating, the fans therefore also taking up space within the printer. As such, the printer, in particular the printer cabinet, tend to be fairly large.

The print head is typically disposed outside of the cabinet. Ink is delivered from the ink supply system, to the print head, and recycled back to the ink supply system via flexible tubes which are bundled together with other fluid tubes and electrical wires into, what is described in the field as, an umbilical. The print head must be coupled either directly or indirectly to the umbilical, and the coupling comprising a plurality of fluid and electrical couplings, the printhead may also be secured to the umbilical by a plurality of fasteners. This can result in large printing systems which are difficult to manoeuvre and reposition.

All non-consumable parts of a continuous inkjet printer do have a service time and/or product lifetime, where they need to be serviced, maintained, repaired, or replaced. The replacement and maintenance of parts can result in undesirable downtime of the printer. Further, if a part needs replacing often a service engineer or technician is required to replace the components of the printer, resulting in further downtime of the printer.

There exists a need to provide an alternative continuous inkjet (CIJ) printer that overcomes one or more of the disadvantages of known systems, whether mentioned in this document or otherwise.

According to a first aspect there is provided a continuous inkjet printer for printing onto an external substrate that moves past the printer, the printer comprising: a printhead, the printhead comprising: a droplet generator configured to generate and eject a stream of ink droplets for printing; at least one electrode configured to steer the stream of ink droplets; and a gutter configured to receive droplets of ink which are not used for printing; and an ink system configured to store ink and supply ink to the printhead; wherein: the printhead is releasably connectable to the ink system by a printhead connection interface, the printhead connection interface comprising a plurality of fluid connectors, a plurality of electrical connectors, and a self-coupling mechanical interlock.

The droplet generator may otherwise be described as a nozzle, as an aperture of a droplet generator, or a jewel. At least some of the ink droplets of the stream of ink droplets may be deflected in operation to apply a printed pattern to the external substrate. That is to say, the ink droplets may be electrically conductive. The droplet generator may comprise a nozzle. The stream of ink droplets generated by the nozzle may be generated by breaking up a continuous stream of ink using, for example, an oscillating piezoelectric element. Droplets may then be directed past a charge electrode where they are given an electric charge, and subsequently guided by a further electrode to direct the now-charged droplet as needed. The at least one electrode for guiding the stream of ink droplets may comprise a zero or negative voltage plate (e.g. the ground plate) and a high voltage (extra high tension (EHT)) plate. The at least one electrode may encompass a pair of deflection plates. A (transverse) electric field is generated across the plates and a charged droplet is deflected by the field by an amount dependent upon the charge and the electric field.

The printhead connection interface comprises an interface between the printhead and a body of the printer, which may include but is not limited to a printer body, a printhead support arm, and an umbilical. The printhead connection interface may comprise all features that connect to or with the body of the printer, or it may comprise only some of the features.

The ink system may comprise a number of components including, but not limited to, a mixing tank, a plurality of pumps, a cartridge, a plurality of filters, a plurality of valves and, optionally, one or more (e.g. an array of) quick disconnect connectors. The ink system may be described as being a closed system in which ink and solvent are received by way of a cartridge, and an appropriate mixture is prepared in the mixing tank ready for printing. Ink is supplied from the mixing tank to the print head.

The plurality of fluid connectors may comprise a main supply line connector and a main return line connector. The main supply line connector may be configured to connect to a main supply fluid conduit, which may be described as extending from at least an ink pump to the nozzle. More specifically, the main supply line may extend from the mixing tank to the nozzle. The main return line connector may be configured to connect to a main return line fluid conduit, which may extend from at least the gutter to a gutter pump, and more preferably from the gutter to the mixing tank. The print head may thus be described as being fluidly coupled to the mixing tank, ink pump and gutter pump when connected to the ink system.

The plurality of fluid connectors may be non-drip connectors.

The plurality of electrical connectors may include at least one low voltage connector and at least one high voltage connector. The at least one high voltage connector may be an extra high voltage (EHV) connector or extra high tension (EHT) connector, wherein the voltage is in the range 6-10 kilovolts. The low voltage connector may comprise a printed circuit board (PCB) connector. Other low voltage connectors may be used, however a PCB connector is advantageous as it is robust and can accommodate variation in connection distance. The PCB connector may comprise a plurality of individually mounted SMT (surface mounted technology) contacts. The low voltage connector May provide a connection for voltages of around 24 V, and up to 300 V AC, or up to 300 V switched DC.

The plurality of electrical connectors may be vertically separated from the plurality of fluid connectors. That is to say the plurality of electrical connectors may be vertically above or vertically below the plurality of fluid connectors. It will be appreciated that the term vertically above and vertically below, need not be directly vertically above or below, an axial spacing may be present in addition to a vertical spacing.

The electrical connections between the connection interface and the ink system May include an early break connection so that the other electrical signals can be powered down in preparation for detachment of the print head from the ink system. That is to say, the electrical connectors may be arranged such that they disconnect before the fluid connectors. In some embodiments, the EHT connector may be arranged to disconnect first. Disconnecting of the electrical connectors may be achieved by the physical arrangement of the connectors (e.g. the electrical connectors may protrude more or less than other connectors). Disconnecting the EHT connector first may then cause other electrical lines and connections to be turned off. For example, the printhead may be arranged so that disconnecting the EHT connector prevents power being provided to other electrical components. In other embodiments, a controller may be arranged to prevent power being supplied to the other electrical lines and connectors if it identifies that the EHT connector has been disconnected.

The term “connection interface” encompasses a region of the printhead which comprises the fluid and electrical connectors, and is arranged for coupling of the connectors with complementary connectors of an ink system. The connectors of the connection interface may all be provided on a single face of the printhead. The connectors of the connection interface may be provided on two or more faces of the printhead. The connectors of the connection interface may be provided on faces of the printhead that are parallel but axially spaced. The fluid and electrical connectors of the connector interface may be “male” connectors configured to be received in a corresponding “female” connectors; or the fluid and electrical connectors of the connector interface may be “female” connectors configured to be received in a corresponding “male” connectors. The fluid connectors may comprise at least one male connector and at least one female connector, the electrical connectors may comprise at least one male connector and at least one female connector.

In some embodiments, the printhead and/or the printhead support arm may comprise a printhead controller, for example a touch screen. The printhead controller may be arranged to control actuation of components of the printhead and/or power supply to components of the printhead. The printhead controller may be in electrical communication with a controller of the continuous inkjet printer

The term “self-coupling mechanical interlock” encompasses a self-locking mechanical coupling assembly, which may be integrally formed with the printhead. A self-coupling mechanical interlock differs from other mechanical fastenings such as threaded screws and bolts, in that it does not require securing or tightening in order to secure the locking assembly. A self-coupling mechanical interlock may include a latch and body mechanism, the body may be a protruding barb, or a clamping arm and a clamping rod. By way of example, a latch may be coupled to a wall of the printhead or to a wall of the printer, and a corresponding barb may be coupled to a wall of the printer or printhead respectively. The latch may comprise a key-hole configured to receive and engage with the barb. The latch and/or the barb may be biased. Any other suitable type of interlock may be provided. A mechanical interlock of these types simple, and has a high tolerance with low creep engagement, thus promoting quick engagement and release of the interlock.

By providing a mechanical interlock, the printhead may be quickly mechanically secured to the ink system, and likewise may be quickly released from the ink system. In addition, the provision of a mechanical interlock mitigates against the plurality of fluid and/or electrical connectors from becoming dislodged or disconnected during use. This is particularly important in relation to the electrical connectors, where at least one of the electrical connectors may be a high voltage electrical connector and/or one of the fluid connectors may be a high pressure fluid connector. The provision of a quick mechanical release mechanism in the form of a mechanical interlock is advantageous as downtime in printing is reduced when removing and replacing a printhead. The printhead may be removed from the ink system in a single motion.

The printhead may further comprise a removable cover, and wherein the removable cover may be removable from the printhead only when the printhead is not connected to the ink system.

According to a second aspect there is provided a continuous inkjet printer for printing onto an external substrate that moves past the printer, the printer comprising: a printhead, the printhead comprising: a droplet generator configured to generate and eject a stream of ink droplets for printing; at least one electrode configured to steer the stream of ink droplets; a gutter configured to receive droplets of ink which are not used for printing; and a removable cover; and an ink system configured to store ink and supply ink to the printhead; wherein: the printhead is releasably connectable to the ink system by a printhead connection interface, the printhead connection interface comprising a plurality of fluid connectors, and a plurality of electrical connectors; and wherein the removable cover is removable from the printhead only when the printhead is not connected to the ink system.

The droplet generator may otherwise be described as a nozzle, as an aperture of a droplet generator, or a jewel. At least some of the ink droplets of the stream of ink droplets may be deflected in operation to apply a printed pattern to the external substrate. That is to say, the ink droplets may be electrically conductive. The droplet generator may comprise a nozzle. The stream of ink droplets generated by the nozzle may be generated by breaking up a continuous stream of ink using, for example, an oscillating piezoelectric element. Droplets may then be directed past a charge electrode where they are given an electric charge, and subsequently guided by a further electrode to direct the now-charged droplet as needed. The at least one electrode for guiding the stream of ink droplets may comprise a zero or negative voltage plate (e.g. the ground plate) and a high voltage (extra high tension (EHT)) plate. The at least one electrode may encompass a pair of deflection plates. A (transverse) electric field is generated across the plates and a charged droplet is deflected by the field by an amount dependent upon the charge and the electric field.

The ink system may comprise a number of components including, but not limited to, a mixing tank, a plurality of pumps, a cartridge, a plurality of filters, a plurality of valves and, optionally, one or more (e.g. an array of) quick disconnect connectors. The ink system may be described as being a closed system in which ink and solvent are received by way of a cartridge, and an appropriate mixture is prepared in the mixing tank ready for printing. Ink is supplied from the mixing tank to the print head.

The plurality of fluid connectors may comprise a main supply line connector and a main return line connector. The main supply line connector may be configured to connect to a main supply fluid conduit, which may be described as extending from at least an ink pump to the nozzle. More specifically, the main supply line may extend from the mixing tank to the nozzle. The main return line connector may be configured to connect to a main return line fluid conduit, which may extend from at least the gutter to a gutter pump, and more preferably from the gutter to the mixing tank. The print head may thus be described as being fluidly coupled to the mixing tank, ink pump and gutter pump when connected to the ink system.

The plurality of fluid connectors may be non-drip connectors.

The plurality of electrical connectors may include at least one low voltage connector and at least one high voltage connector. The at least one high voltage connector may be an extra high voltage (EHV) connector or extra high tension (EHT) connector, wherein the voltage is in the range 6-10 kilovolts. The low voltage connector may comprise a printed circuit board (PCB) connector. Other low voltage connectors may be used, however a PCB connector is advantageous as it is robust and can accommodate variation in connection distance. The PCB connector may comprise a plurality of individually mounted SMT (surface mounted technology) contacts. The low voltage connector may provide a connection for have a voltages of around 24 V, and up to 300 V AC, or up to 300 V switched DC.

The plurality of electrical connectors may be vertically separated from the plurality of fluid connectors. That is to say the plurality of electrical connectors may be vertically above or vertically below the plurality of fluid connectors. It will be appreciated that the term vertically above and vertically below, need not be directly vertically above or below, an axial spacing may be present in addition to a vertical spacing.

The electrical connections between the connection interface and the ink system may include an early break connection so that the other electrical signals can be powered down in preparation for detachment of the print head from the ink system. That is to say, the electrical connectors may be arranged such that they disconnect before the fluid connectors. In some embodiments, the EHT connector may be arranged to disconnect first. Disconnecting of the electrical connectors may be achieved by the physical arrangement of the connectors (e.g. the electrical connectors may protrude more or less than other connectors). Disconnecting the EHT connector first may then cause other electrical lines and connections to be turned off. For example, the printhead may be arranged so that disconnecting the EHT connector prevents power being provided to other electrical components. In other embodiments, a controller may be arranged to prevent power being supplied to the other electrical lines and connectors if it identifies that the EHT connector has been disconnected.

The term “connection interface” encompasses a region of the printhead which comprises the fluid and electrical connectors, and is arranged for coupling of the connectors with complementary connectors of an ink system. The connectors of the connection interface may all be provided on a single face of the printhead. The connectors of the connection interface may be provided on two or more faces of the printhead. The connectors of the connection interface may be provided on faces of the printhead that are parallel but axially spaced. The fluid and electrical connectors of the connector interface may be “male” connectors configured to be received in a corresponding “female” connectors; or the fluid and electrical connectors of the connector interface may be “female” connectors configured to be received in a corresponding “male” connectors. The fluid connectors may comprise at least one male connector and at least one female connector, the electrical connectors may comprise at least one male connector and at least one female connector.

In some embodiments, the printhead and/or the printhead support arm may comprise a printhead controller, for example a touch screen. The printhead controller may be arranged to control actuation of components of the printhead and/or power supply to components of the printhead. The printhead controller may be in electrical communication with a controller of the continuous inkjet printer.

The removable cover may comprise an aperture, in particular an elongated aperture for ejection of the stream of ink droplets.

The removable cover prevents access to components of the printhead during operation, this has the advantage of protecting the features of the printhead from external factors and environmental conditions such as moisture, dust, foreign particulates and extreme temperatures; but also the advantage of protecting an operator or a third person from contacting components of the printhead which during operation may have a high voltage (i.e. a voltage that could cause serious injury or death to a person) from contacting said components.

By the cover only being able to be removed when the printhead is not connected to the system prevents a user or operator from contacting the high voltage components during a printing operation, thus increasing the safety of the printer.

By the cover only being removable when the printhead is not connected to the ink system, i.e. when there is no fluid or electrical connection between the printhead and ink system promotes safe use of the printhead since no high voltage parts of the printhead can be contacted during operation. Furthermore, this allows a single printhead to be quickly and safely removed and replaced, rather than requiring the removable cover to be removed in order to access for example a printhead release screw to then remove the printhead.

The printhead connection interface may further comprise a self-coupling mechanical interlock.

The mechanical interlock may be configured to prevent removal of the printhead unless a safety condition is satisfied.

That is to say the mechanical interlock may not be released until a safety condition is satisfied. By not being able to release the mechanical interlock until a safety condition is satisfied prevents the printhead being removed or disconnected from the ink system.

This may prevent the printhead from being mistakenly detached from the second support member whilst printing, in which case printer fluid may inadvertently come into contact with the electrical connectors on the print head or second support member.

The safety condition that is to be satisfied may include at least one of the following:
There is no transfer of power between the plurality of electrical connectors;
There is no voltage drop across the plurality of electrical connectors;
There is no passage of fluid between the fluid connectors.

The printhead connection interface may comprise a release trigger, configured to initiate a release sequence.

The release sequence may comprise determining if the safety condition is satisfied and releasing the mechanical interlock only when the safety condition is satisfied.

The term release trigger encompasses a release button, a touch screen, or may be implemented by a feature of a printhead such as a push button. By providing a release trigger to initiate a release sequence, safe removal of the printhead can occur. For example, the actuation of the release trigger may cause all power supply to electrical components of the printhead to be terminated before the printhead can be disconnected from the printhead support arm.

In other embodiments, the release trigger may not form part of the printhead connection interface.

The first step of the release sequence may be to shut down the ink jet. In particular, to stop ink being ejected from the nozzle of the printhead. Shutting down the inkjet may be initiated by a user. For example, a user may engage the release trigger which initiates the release sequence. Initiation of the release trigger may cause shut down of the inkjet. However, shut down of the ink jet may be caused, for example if one of the electrical components of the printhead or the printer trips. e.g. if the extra high tension electrical connector trips. The printer may alert the user if the ink jet is stopped due to a component or electrical failure. Shutting down of the ink jet may initiate the release sequence.

Following shut down of the ink jet. One or more safety checks may be completed. Once the safety checks are completed, and hence safety conditions are satisfied removal of the printhead may be permitted. Possible safety checks include but are not limited to:
checking that EHT is off. This may be implemented by a controller checking that no power is supplied to the printhead via the EHT connector.
checking that power supply to the electrical components of the printhead is off (save as for the solenoid, if a solenoid is present).
Checking that an ink pump of the printer is off.
Checking that a solvent pump of the printer is off.
Checking that a gutter pump of the printer is off.
Checking that a pressure transducer is less than a predetermined pressure. In particular, the pressure may be less than around 0.1 bar.
Check that the fluid control valves are closed.

In embodiments which comprise an electrical lock, such as a solenoid. Unlocking of the electrical lock may be prohibited until the safety conditions are satisfied.

The continuous inkjet printer may further comprise an electrical lock configured to electrically lock the self-coupling mechanical interlock.

The term electrical lock encompasses a solenoid, in particular a solenoid release actuator. The printhead may comprise the electrical lock. The electrical lock may be arranged to prevent disconnection of the mechanical interlock during operation of the printer. By way of example, a solenoid release actuator may be actuated to engage with the mechanical interlock so as to prevent de-coupling of the mechanical interlock, and the mechanical interlock may only be able to decouple and hence allow removal of the printhead when the solenoid release actuator is not engage with the mechanical interlock.

The self-coupling mechanical interlock may comprise a latch for engagement with a corresponding locking body of the continuous inkjet printer.

The self-coupling mechanical interlock may be arranged to provide quick and safe release of the printhead from the ink system.

By way of example, a latch may be coupled to a wall of the printhead or to a wall of the printer, and a corresponding locking body, such as a barb may be coupled to a wall of the printer or printhead respectively. The latch may comprise a key-hole configured to receive and engage with the barb. The latch and/or the barb may be biased. Any other suitable type of interlock may be provided. A self-coupling mechanical interlock of these types is simple, and has a high tolerance with low creep engagement, thus promoting quick engagement and release of the interlock.

That is to say the printhead may be quickly disconnected from the printer. In particular, the printhead may be quickly disconnected from an umbilical or from a printhead support arm. The arrangement to allow quick disconnection, may include a user or operator needing to only release the mechanical interlock, for example by actuating a mechanical push button, and/or an electronic switch, when then allows the user to disconnect the printhead in a single movement (e.g. pulling the printhead away from the printer). The self-coupling mechanical interlock may provide safe release of the printhead, as the self-coupling mechanical interlock may be arranged so that it cannot be de-coupled from the ink system without a user input, for example a user actuating a push button. This is advantageous as downtime in printing is reduced when removing and replacing a printhead. The printhead may be removed from the ink system in a single motion.

The continuous inkjet printer may comprise a controller, and wherein at least one of the plurality of fluid connectors, and/or at least one of the plurality of electrical connectors may comprise a sensor, and the controller may be operable to receive signals from the sensor.

The signals that the controller receives may be indicative of a status of the connector that is associated with the sensor. By way of example, the sensor may be able to send a signal that is indicative of whether a valve of a fluid connector is open or closed. Likewise, the sensor may be able to send a signal that is indicative of whether electrical power is passing through the electrical connector. The continuous inkjet printer may comprise a plurality of sensors. Based upon the signals received by the controller, the controller may be configured to determine if a safety condition is satisfied. The controller may be configured to permit disconnection of the printhead when a safety condition is satisfied. In particular, the controller may be able to allow the de-coupling of the self-coupling mechanical interlock when a safety condition is satisfied; or when a pre-determined signal or set of signals is received by the controller. By not being able to release the mechanical interlock and hence disengage the plurality of fluid connectors and electrical connectors until the safety condition is satisfied mitigates against a user who may be trying to remove the printhead from contacting a live voltage source or connector.

The self-coupling mechanical interlock may be engaged and released without use of a tool.

The self-coupling mechanical interlock may be configured to engage only when the plurality of fluid connectors and the plurality of electrical connectors are engaged with their corresponding connectors of the ink system

That is to say, a user may be able to engage and release the self-coupling mechanical interlock using only their hands and without the need to use a tool such as a screwdriver, wrench etc. In particular, a user may be able to engage and release the self-coupling mechanical interlock without using any rotational movement (i.e. the user is not required to unscrew or un-twist any mechanical securing feature).

The disengagement and engagement of the mechanical interlock without a tool further reduces printing downtime when removing and replacing a printhead, and may mitigate against the need to for a specialised service technician to remove and replace the printhead.

This is advantageous, since the self-coupling mechanical interlock ensures engagement of the plurality of fluid connectors and the plurality electrical connectors with the corresponding connectors of the ink system.

A distal end of the plurality of fluid connectors may be offset from a distal end of the plurality of electrical connectors.

That is to say, the distal ends of the plurality of the fluid connectors do not lie in the same plane as the distal ends of the plurality of electrical connectors. This mitigates against fluid, in particular ink or solvent, from the fluid connectors dripping onto and damaging the electrical connectors.

Further, providing the fluid and electrical connectors on a connection interface, preferably, on a single face of a connection interface, or on faces of the connection interface that are parallel but axially spaced improves forming secure connections with complementary connectors of the ink system.

At least one of the plurality of fluid connectors may comprise a self-sealing fluid valve for preventing leaking of printing fluid when the printhead is removed.

The printer may be configured to permit the printhead to be removed from the printer and connected to the printer without the use of any tools.

The printhead may be configured so that ink (or other fluid) does not leak out on disconnection of the print head from the ink system. At least one of the plurality of fluid connectors may comprise a self sealing valve.

The continuous inkjet printer may comprise a self-sealing valve assembly for the complementary connectors that connect to the fluid connectors. Having the assembly outside of the print head may allow for a smaller size for the print head. However, the assembly could otherwise be provided in the print head. The assembly may be configured to automatically open when the print head is connected to the second ink system and to automatically seal closed when disconnected from the ink system. Being open may mean that fluid can flow along a fluid flow path between the ink system and the printhead. Being closed may mean that fluid is prevented from flowing from out of the ink system, and so the fluid path is broken. The assembly may minimise or eliminate fluid leakage upon removal or disconnection of the print head from the ink system.

To be put another way, a user or operator of the printer may be able to connect a printhead to the printer using only their hands, and similarly, may be able to remove the printhead from the printer using only their hands. Because tools are not needed to, for example, release fasteners, the printhead may be quickly connected to and removed from the printer. Accordingly, down time of the printer is reduced when removing an replacing a printhead.

The printer may comprise a printhead support coupled to the ink system, the printhead connection interface may be supported by components of the printhead support and the printhead.

The printhead support may be rotatably coupled to printer.

The printhead support may be referred to as a printhead support member, or as a printhead support arm. That is to say, the print head may be indirectly connected to the ink system via one or more interposing components, such as a print head support arm (e.g. a tiltable portion, or non-tiltable portion, of a print head support arm). The print head support arm may be pivotally connected to the printer body by a rotatable coupling. The rotatable coupling may be configured to permit the print head to rotate relative to the printer body about a print head rotation axis. Alternatively, the printhead support arm may be rigidly fixed to a printer, or may be mounted in a printing location. When the printhead support arm is mounted at a printing location, the printhead support arm may be connected to an umbilical.

The printhead support may be pivotally connected to the printer body by a rotatable coupling. The rotatable coupling may be configured to permit the print head support and hence the printhead to rotate relative to the ink system about a print head rotation axis.

The continuous inkjet printer may comprise a product detection sensor to sense the position of the external substrate.

The printhead support may comprise the product detection sensor.

The product detection sensor may comprise a sensor beam. The product detection sensor may comprise one or more lenses. The product detection sensor may be arranged to detect the product/substrate to which ink droplets are to be printed onto and may be able to sense the direction and speed of the product. The sensor may be a standard sensor, for example a proximity sensor. The product detection sensor may comprise a photoelectric sensor (also known as a photocell pair sensor), which may use infrared radiation, or may comprise a pin hole sensor.

The product detection sensor being placed on the printhead support member allows for a more compact printhead. In addition, the cost of producing a printhead may be reduced as the printhead does not need to comprise a product detection sensor.

The product detection sensor may comprise a plurality of detection sensors. The product detection sensor may comprise two sensors. In embodiments where the product detection sensor comprises two sensors, one sensor may be provided at either side of the location where ink droplets are ejected from the printhead.

The product detection sensor may be set back from the location or aperture at which ink droplets are ejected from the printhead. This mitigates against ink droplets splattering on the sensor.

The product detection sensor may be positioned less than around 5 millimetres from the gutter. Preferably, the detection area, i.e. the area that the product detection sensor 1305 covers, should be less than 5 mm below the gutter. This is so that the product detection sensor 1305 can sense in the area where printing is required.

The removable cover may prevent access to the droplet generator, the at least one electrode and the gutter when covering the printhead.

The removable cover may be removed from the printhead without a tool.

In other words, when the removable cover is removed at least one of the droplet generator, the at least one electrode, and the gutter may be accessed.

Providing a removable cover allows ease of access to the components of the printhead, in particular to at least one of the droplet generator, the at least one electrode, and the gutter can be accessed. This allows easy access to printhead components for servicing, maintenance and replacement and replacement of components. Yet the removable cover protects the components of the printhead from external factors and environmental conditions such as moisture, dust, foreign particulates and extreme temperatures, in particular during printing operations.

When the printhead cover is removed the droplet generator, the at least one electrode and the gutter may all be able to be accessed by a user.

That is to say, a user may be able to remove the removable using only their hands and without the need to use a tool such as a screwdriver, wrench etc.

The removable cover may comprise clips which cooperate with grooves in the printhead in a ‘pinch and withdraw’ type mechanism. The clips may each have a protrusion that cooperates with, and/or abuts, a step, or stepped portion, within their respective groove such that when the clips are fully inserted into the grooves, the clips may not be pulled out of the grooves with a purely linear motion. The user may need to bias (e.g. ‘pinch’) the clips so that the protrusion can overcome the stepped portion and can then be pulled out of the groove with a purely linear motion. As such the removable cover may be removed from the printhead using a “pinch and withdraw” type mechanism.

In other embodiments, the removable cover may only be removed with use of a tool. For example, the removable cover may only be removed if an unlocking “key” is inserted into a locking mechanism of the removable. The advantage of requiring a tool to in order to remove the cover is that it mitigates against unauthorised users from removing the cover, and thereby mitigates against an unauthorised user damaging the components of the printhead.

The printhead connection interface may comprise cooperating guide features configured to guide the printhead into a connected configuration from a disconnected configuration.

The term “cooperating guide features” encompasses alignment features or alignment means. The cooperating guide features help provide for a quick and easy connection or disconnection of the printhead to the ink system. Corresponding cooperating guide means may be provided on the printer, or on a second member or on a print head support member, without the need for any difficult alignment.

The guide features may form part of the printhead connection interface. The advantage of providing guide features, is that mis-alignment of the fluid and electrical connectors of the printhead with corresponding connectors of the ink system is mitigated. Thereby mitigating against damage to fluid and electrical connectors.

A first guide feature may be provided on the printer and a second guide feature may be provided on the printhead.

In particular, the first guide feature may be provided on a printhead support, in particular on a printhead support arm.

Advantageously, mis-alignment of the fluid and electrical connectors of the printhead with corresponding connectors of the ink system is mitigated. Thereby mitigating against damage to fluid and electrical connectors. Furthermore, by providing a guide feature of the printer and a second guide feature on the printhead, the printhead must be correctly orientated, again mitigating against misalignment of corresponding connectors.

The guide features may comprise a guide rail or a guide groove. The term “guide rail” encompasses one or more guide pins or rails for cooperating with one or more guide runners or grooves on a surface of the print head. The printer may comprise two guide rails and the print head may comprise two cooperating guide grooves. In particular, a print head support member may comprise the two guide rails. The one or more guide pins or rails and the one or more guide runners or grooves may be linear. The one or more guide pins or rails may readily slot into the one or more guide runners or grooves and are configured with a sliding relationship. As such, the one or more guide pins or rails may slide through the one or more guide runners or grooves to provide for easy connection/disconnection and alignment of the print head and second support member. One or more suitable stops may be provided in the one or more guide runners or grooves so that the print head is forced to stop sliding when the various electrical and fluid connectors and the complementary connectors connect.

The print head may instead comprise the one or more guide pins or rails and the second support member may comprise the one or more guide runners or grooves. Alternatively, the alignment means may comprise any other suitable mechanisms that may also have other types of mechanical relationship, for example the print head may roll into place on the second support member.

The continuous inkjet printer may further comprise a printhead support for supporting the printhead, wherein the cooperating guide features may be configured to allow only generally linear movement of the printhead relative to the printhead support.

The printhead support may be a printhead support arm. The printhead support arm may comprise a plurality of fluid and electrical connectors for connection to corresponding connectors of the printhead. The printhead support arm may be rigidly attached to the continuous inkjet printer, or may be provided at the end of an umbilical, or may partly define a rotatable and/or tillable support arm as defined herein. That is to say, when connecting and disconnecting the printhead, in particular the electrical connectors and the fluid connectors from the corresponding connectors of the ink system. The guide rails are configured to allow only linear motion of the printhead. In doing so, and lateral and orthogonal movement of the printhead is generally prohibited. This is particularly advantageous at the point of connection and disconnection of the printhead, as any non-linear connection of disconnection of the fluid and electrical connectors could result in damage to the connectors. Additionally, it also allows from rapid connection and disconnection of the printhead, as at the point of connection the corresponding electrical and fluid connectors are aligned. Therefore, the moment required by a user is restricted to one dimensional movement.

The guide features may extend along over 75% a length of the printhead. The guide features may extend along over between 75% and 95% of the printhead.

The length of the printhead is to be understood as the length of the printhead which the guide features are provided on. Because the guide features extend over 75% of the length of the printhead, this further reduces any lateral or orthogonal movement that may occur at the point of engaging the corresponding electrical and fluid connectors.

The guide features may comprise a first guide region configured to provide coarse guidance and a second guide region configured to provide fine guidance and a tapered region between the first guide region and the second guide region.

Providing a first coarse guidance aids in quick connection of the printhead to the ink system. This is because a user who is connecting a printhead to the ink system does not need to spend time precisely aligning the guide features provided on the printhead with corresponding guide features on the printer. Instead, a user may generally align the guide features of the printhead with the corresponding guide features of the printer and as the user moves the plurality of fluid and electrical connectors towards the corresponding connectors, first guide region allows the user to guide the printhead towards the second guide region, where the second guide region ensures that the fluid and electrical connectors of the printhead will align with the corresponding connectors of the printer.

In addition to providing alignment of corresponding connectors between the printhead and printer, the guide features may also mitigate against damage to the connectors by ensuring that the printhead is always provided in the correct orientation, and if in the incorrect orientation, the guide features causing an offset between the connectors on the print head and corresponding connectors of the ink system, such that a user cannot inadvertently attempt to connect two non-corresponding connectors.

The printer may be configured to permit the printhead to be removed from printer, and for an alternative printhead to be connected to the printer, and for printing operations to commence within a period of around 2 minutes.

The alternative printhead may be the printhead that was removed from the printer.

Printing operations may commence within a period of around 3 minutes. Printing operations may commence within a period of between around 2 minutes to around 3 minutes. Printing operations may commence within a period of between around 1 minute to around 3 minutes. Printing operations may commence within a period of between around 1 minute to around 2 minutes.

The printer may be configured to permit the printhead to be removed from the printer in around 10 seconds or less. That is to say, within around 10 seconds or less a user may initiate removal of the printhead and the printhead be disconnected from the printhead support arm. In other words, within around 10 seconds or less the printhead can be removed so that it is not in mechanical, electrical, and fluid communication with the printhead support arm. In particular, the printhead may be removed within around 10 seconds or less from one or more safety conditions being satisfied.

Prior to removing the printhead from the printhead support arm, a user may (i) in embodiments that comprise an electrical locking mechanism deactivate the electrical locking mechanism i.e. move a solenoid from an extended positon to a retracted position; and/or (ii) stop power supply to components of the printhead.

After removing the printhead from the printhead support arm, as user may (i) provide the alternative printhead, connect the printhead connection interface of the alternative printhead with the printhead support arm, optionally electrically lock the alternative printhead to the printhead support arm. Electrical power may then be provided the components of the alternative printhead, and printing operations may commence. Printing operations may include ink being ejected from the printhead to be printed on a substrate. The time taken to provide the alternative printhead ad commence printing operations may be around 50 seconds.

The continuous inkjet printer may comprise a controller; the controller may be arranged to check that before the printhead is disconnected there is no current supplied to components of the printhead.

This promotes safe removal of the printhead by mitigating a user from removing the printhead during printing operations.

That is to say, before disconnection of the printhead is permitted the controller is arranged to check that there is no current through components of the printhead, for example to a charge electrode and/or to deflection plates. It will be appreciated that if the printhead comprises electrical locking means, such as a solenoid, a current may still be applied to the solenoid so as to permit actuation of the solenoid.

It will be appreciated that features of the second aspect may be combined with the first aspect, and features of the first aspect may be combined with features of the second aspect.

According to a third aspect there is provided A printhead for a continuous inkjet printer, the printhead comprising: a droplet generator configured to generate and eject a stream of ink droplets for printing; at least one electrode configured to steer the stream of ink droplets; and a gutter configured to receive droplets of ink which are not used for printing;

and wherein the printhead is releasably connectable to an ink system of a continuous inkjet system by a printhead connection interface, the printhead connection interface comprising a plurality of electrical connectors, a plurality of fluid connectors, and a self-coupling mechanical interlock.

The printhead may comprise a removable cover and wherein the removable cover may be removable from the printhead only when the printhead is not connected to the ink system.

According to a fourth aspect there is provided a printhead for a continuous inkjet printer, the printhead comprising: a droplet generator configured to generate and eject a stream of ink droplets for printing; at least one electrode configured to steer the stream of ink droplets; and a gutter configured to receive droplets of ink which are not used for printing, and a removable cover; and wherein the printhead is releasably connectable to an ink system of a continuous inkjet system by a printhead connection interface, the printhead connection interface comprising a plurality of electrical connectors, and a plurality of fluid connectors, and wherein the removable cover is removable from the printhead only when the printhead is not connected to the ink system.

The printhead connection interface may further comprises a self-coupling mechanical interlock.

The self-coupling mechanical interlock may be configured to prevent removal of the printhead unless a safety condition is satisfied.

The printhead connection interface may comprise a release trigger, configured to initiate a release sequence.

The release sequence may comprise determining if the safety condition is satisfied and releasing the mechanical interlock when the safety condition is satisfied.

The mechanical interlock may comprise a solenoid release actuator.

The removable cover may prevent access to the droplet generator, the at least one electrode and the gutter when the removable cover is covering the printhead.

The removable cover may be removed from the printhead without a tool.

The printhead connection interface may comprise cooperating guide features configured to guide the printhead into a connected configuration from a disconnected configuration.

The printer may be configured to permit the printhead to be removed from printer, and for an alternative printhead to be connected to the printer, and for printing operations to commence within a period of around 2 minutes.

Features of the third aspect may be combined with the first, second, or fourth aspect. Features of the fourth aspect may be combined with features of the first, second, or third aspect.

According to a fifth aspect there is provided a method of operating a continuous inkjet printer for printing onto an external substrate that moves past the printer, the printer comprising a printhead and an ink system for storing ink and supplying ink to the printhead, wherein the printhead is releasably connectable to the ink system; the printhead comprising: a droplet generator configured to generate and eject a stream of ink droplets for printing; at least one electrode configured to steer the stream of ink droplets; and a gutter configured to receive droplets of ink which are not used for printing; wherein the printhead is releasably connectable to the ink system by a printhead connection interface, the printhead connection interface comprising a plurality of fluid connectors, a plurality of electrical connectors, and a self-coupling mechanical interlock;

the method comprising: connecting the plurality of fluid connectors to corresponding connections of the printer; connecting the plurality of electrical connectors to corresponding connections of the printer; and engaging the self-coupling mechanical interlock to prevent removal of the printhead.

The printhead may further comprise a removable cover, and the method may comprise removing the removable cover when the printhead is not connected to the ink system.

According to a sixth aspect there is provided a method of operating a continuous inkjet printer for printing onto an external substrate that moves past the printer, the printer comprising a printhead and an ink system for storing ink and supplying ink to the printhead, wherein the printhead is releasably connectable to the ink system; the printhead comprising: a droplet generator configured to generate and eject a stream of ink droplets for printing; at least one electrode configured to steer the stream of ink droplets; a removable cover; and a gutter configured to receive droplets of ink which are not used for printing; wherein the printhead is releasably connectable to the ink system by a printhead connection interface, the printhead connection interface comprising a plurality of fluid connectors, a plurality of electrical connectors; the method comprising: disconnecting the plurality of fluid connectors from the corresponding connectors of the printer; disconnecting the plurality of electrical connectors from corresponding connectors of the printer; and removing the removable cover when the printhead is not connected to the plurality of electrical connectors and the plurality of fluid connectors.

When the printhead connection interface may comprises a self-coupling mechanical interlock, the method may comprise engaging the self-coupling mechanical interlock to prevent removal of the printhead, prior to disconnecting the fluid connectors and electrical connectors

The method may comprise satisfying a safety condition; releasing the mechanical interlock to allow removal of the printhead.

A controller may be used to determine that the safety condition is satisfied.

The printhead connection interface may comprise a release trigger, and the method may comprise: actuating the release trigger; initiating a printhead release sequence.

The printhead release sequence may include
shutting down the ink jet
checking that at least one or more safety conditions are satisfied
disengaging the solenoid
removing the printhead.

The step of checking that the at least one safety condition is satisfied may be omitted in some embodiments, or may be manually overridden by a user.

The step of disengaging the solenoid may not be present in embodiments which do not comprise a solenoid.

Removing the removable cover may include pinching and withdrawing the removable cover.

The method may further comprise satisfying at least one safety condition and removing the removable cover after the safety condition is satisfied.

A controller may be used to determine that the safety condition is satisfied.

The printhead connection interface may comprise cooperating guide features configured to guide the printhead into a connected configuration from a disconnected configuration, and the method may comprise: aligning the cooperating guide features; connecting the plurality of fluid connectors to corresponding connections of the printer; connecting the plurality of electrical connectors to corresponding connections of the printer.

The method may further comprise sliding the printhead towards a printhead support member.

The method may comprise: within a period of around 2 minutes: removing the printhead from the printer; providing an alternative printhead; connecting the plurality of fluid connectors of the alternative printhead to corresponding connections of the printer; connecting the plurality of electrical connectors of the alternative printhead to corresponding connections of the printer; resuming printing operations.

The printhead may be configured to be removed from the printer within a period of around seconds or less from one or more safety conditions being satisfied.

Removing the printhead may take place in around 10 seconds. Removing of the printhead encompasses moving the printhead such that the plurality of fluid and plurality of electrical connectors are not engages with corresponding connectors of a printhead support arm connection interface, an umbilical or the like. Safety checks being satisfied encompass checking that EHT connector is off, that no power is supplied to the printhead and the like which may be printer specific. In some embodiments safety checks may not be required and the period of 10 seconds or less may be from when ejection of an ink jet of the printhead is stopped.

Features of the fifth aspect may be combined with features of the first to fourth aspects and with the sixth aspect. Features of the sixth aspect may be combined with features of the first to fifth aspects.

According to a seventh aspect there is provided a continuous inkjet printer for printing onto an external substrate that moves past the printer, the printer comprising: a printhead, the printhead comprising: a droplet generator configured to generate and eject a stream of ink droplets for printing; at least one electrode configured to steer the stream of ink droplets; and a gutter configured to receive droplets of ink which are not used for printing; and an ink system configured to store ink and supplying ink to the printhead; wherein: the printhead is releasably connectable to the ink system by a printhead connection interface, the printhead connection interface comprising a plurality of fluid connectors, a plurality of electrical connectors; and the printer is configured to permit the printhead to be removed from printer, and for an alternative printhead to be connected to the printer, and for printing operations to commence within a period of around 2 minutes.

The droplet generator may otherwise be described as a nozzle, as an aperture of a droplet generator, or a jewel. At least some of the ink droplets of the stream of ink droplets may be deflected in operation to apply a printed pattern to the external substrate. That is to say, the ink droplets may be electrically conductive. The droplet generator may comprise a nozzle. The stream of ink droplets generated by the nozzle may be generated by breaking up a continuous stream of ink using, for example, an oscillating piezoelectric element. Droplets may then be directed past a charge electrode where they are given an electric charge, and subsequently guided by a further electrode to direct the now-charged droplet as needed. The at least one electrode for guiding the stream of ink droplets may comprise a zero or negative voltage plate (e.g. the ground plate) and a high voltage (extra high tension (EHT)) plate. The at least one electrode may encompass a pair of deflection plates. A (transverse) electric field is generated across the plates and a charged droplet is deflected by the field by an amount dependent upon the charge and the electric field.

The ink system may comprise a number of components including, but not limited to, a mixing tank, a plurality of pumps, a cartridge, a plurality of filters, a plurality of valves and, optionally, one or more (e.g. an array of) quick disconnect connectors. The ink system may be described as being a closed system in which ink and solvent are received by way of a cartridge, and an appropriate mixture is prepared in the mixing tank ready for printing. Ink is supplied from the mixing tank to the print head.

The plurality of fluid connectors may comprise a main supply line connector and a main return line connector. The main supply line connector may be configured to connect to a main supply fluid conduit, which may be described as extending from at least an ink pump to the nozzle. More specifically, the main supply line may extend from the mixing tank to the nozzle. The main return line connector may be configured to connect to a main return line fluid conduit, which may extend from at least the gutter to a gutter pump, and more preferably from the gutter to the mixing tank. The print head may thus be described as being fluidly coupled to the mixing tank, ink pump and gutter pump when connected to the ink system.

The plurality of fluid connectors may be non-drip connectors.

The plurality of electrical connectors may include at least one low voltage connector and at least one high voltage connector. The at least one high voltage connector may be an extra high voltage (EHV) connector or extra high tension (EHT) connector, wherein the voltage is in the range 6-10 kilovolts. The low voltage connector may comprise a printed circuit board (PCB) connector. Other low voltage connectors may be used, however a PCB connector is advantageous as it is robust and can accommodate variation in connection distance. The PCB connector may comprise a plurality of individually mounted SMT (surface mounted technology) contacts. The low voltage connector may provide a connection for have a voltages of around 24 V, and up to 300 V AC, or up to 300 V switched DC.

The plurality of electrical connectors may be vertically separated from the plurality of fluid connectors. That is to say the plurality of electrical connectors may be vertically above or vertically below the plurality of fluid connectors. It will be appreciated that the term vertically above and vertically below, need not be directly vertically above or below, an axial spacing may be present in addition to a vertical spacing.

The electrical connections between the connection interface and the ink system may include an early break connection so that the other electrical signals can be powered down in preparation for detachment of the print head from the ink system. That is to say, the electrical connectors may be arranged such that they disconnect before the fluid connectors. In some embodiments, the EHT connector may be arranged to disconnect first. Disconnecting of the electrical connectors may be achieved by the physical arrangement of the connectors (e.g. the electrical connectors may protrude more or less than other connectors). Disconnecting the EHT connector first may then cause other electrical lines and connections to be turned off. For example, the printhead may be arranged so that disconnecting the EHT connector prevents power being provided to other electrical components. In other embodiments, a controller may be arranged to prevent power being supplied to the other electrical lines and connectors if it identifies that the EHT connector has been disconnected.

The term “connection interface” encompasses a region of the printhead which comprises the fluid and electrical connectors, and is arranged for coupling of the connectors with complementary connectors of an ink system. The connectors of the connection interface may all be provided on a single face of the printhead. The connectors of the connection interface may be provided on two or more faces of the printhead. The connectors of the connection interface may be provided on faces of the printhead that are parallel but axially spaced. The fluid and electrical connectors of the connector interface may be “male” connectors configured to be received in a corresponding “female” connectors; or the fluid and electrical connectors of the connector interface may be “female” connectors configured to be received in a corresponding “male” connectors. The fluid connectors may comprise at least one male connector and at least one female connector, the electrical connectors may comprise at least one male connector and at least one female connector.

In some embodiments, the printhead and/or the printhead support arm may comprise a printhead controller, for example a touch screen. The printhead controller may be arranged to control actuation of components of the printhead and/or power supply to components of the printhead. The printhead controller may be in electrical communication with a controller of the continuous inkjet printer.

The alternative printhead may be the printhead that was removed from the printer.

Printing operations may commence within a period of around 3 minutes. Printing operations may commence within a period of between around 2 minutes to around 3 minutes. Printing operations may commence within a period of between around 1 minute to around 3 minutes. Printing operations may commence within a period of between around 1 minute to around 2 minutes.

The printhead connection interface may comprise cooperating guide features configured to guide the printhead into a connected configuration from a disconnected configuration.

The term “cooperating guide features” encompasses alignment features or alignment means. The cooperating guide features help provide for a quick and easy connection or disconnection of the printhead to the ink system. Corresponding cooperating guide means may be provided on the printer, or on a second member or on a print head support member, without the need for any difficult alignment.

The guide features may form part of the printhead connection interface. The advantage of providing guide features, is that mis-alignment of the fluid and electrical connectors of the printhead with corresponding connectors of the ink system is mitigated. Thereby mitigating against damage to fluid and electrical connectors.

According to an eighth aspect there is provided a continuous inkjet printer for printing onto an external substrate that moves past the printer, the printer comprising: a printhead, the printhead comprising: a droplet generator configured to generate and eject a stream of ink droplets for printing; at least one electrode configured to steer the stream of ink droplets; and a gutter configured to receive droplets of ink which are not used for printing; and an ink system configured to store ink and supplying ink to the printhead; wherein: the printhead is releasably connectable to the ink system by a printhead connection interface, the printhead connection interface comprising a plurality of fluid connectors, a plurality of electrical connectors, and cooperating guide features configured to guide the printhead into a connected configuration from a disconnected configuration.

The droplet generator may otherwise be described as a nozzle, as an aperture of a droplet generator, or a jewel. At least some of the ink droplets of the stream of ink droplets may be deflected in operation to apply a printed pattern to the external substrate. That is to say, the ink droplets may be electrically conductive. The droplet generator may comprise a nozzle. The stream of ink droplets generated by the nozzle may be generated by breaking up a continuous stream of ink using, for example, an oscillating piezoelectric element. Droplets may then be directed past a charge electrode where they are given an electric charge, and subsequently guided by a further electrode to direct the now-charged droplet as needed. The at least one electrode for guiding the stream of ink droplets may comprise a zero or negative voltage plate (e.g. the ground plate) and a high voltage (extra high tension (EHT)) plate. The at least one electrode may encompass a pair of deflection plates. A (transverse) electric field is generated across the plates and a charged droplet is deflected by the field by an amount dependent upon the charge and the electric field.

The ink system may comprise a number of components including, but not limited to, a mixing tank, a plurality of pumps, a cartridge, a plurality of filters, a plurality of valves and, optionally, one or more (e.g. an array of) quick disconnect connectors. The ink system may be described as being a closed system in which ink and solvent are received by way of a cartridge, and an appropriate mixture is prepared in the mixing tank ready for printing. Ink is supplied from the mixing tank to the print head.

The plurality of fluid connectors may comprise a main supply line connector and a main return line connector. The main supply line connector may be configured to connect to a main supply fluid conduit, which may be described as extending from at least an ink pump to the nozzle. More specifically, the main supply line may extend from the mixing tank to the nozzle. The main return line connector may be configured to connect to a main return line fluid conduit, which may extend from at least the gutter to a gutter pump, and more preferably from the gutter to the mixing tank. The print head may thus be described as being fluidly coupled to the mixing tank, ink pump and gutter pump when connected to the ink system.

The plurality of fluid connectors may be non-drip connectors.

The plurality of electrical connectors may include at least one low voltage connector and at least one high voltage connector. The at least one high voltage connector may be an extra high voltage (EHV) connector or extra high tension (EHT) connector, wherein the voltage is in the range 6-10 kilovolts. The low voltage connector may comprise a printed circuit board (PCB) connector. Other low voltage connectors may be used, however a PCB connector is advantageous as it is robust and can accommodate variation in connection distance. The PCB connector may comprise a plurality of individually mounted SMT (surface mounted technology) contacts. The low voltage connector may provide a connection for have a voltages of around 24 V, and up to 300 V AC, or up to 300 V switched DC.

The plurality of electrical connectors may be vertically separated from the plurality of fluid connectors. That is to say the plurality of electrical connectors may be vertically above or vertically below the plurality of fluid connectors. It will be appreciated that the term vertically above and vertically below, need not be directly vertically above or below, an axial spacing may be present in addition to a vertical spacing.

The electrical connections between the connection interface and the ink system may include an early break connection so that the other electrical signals can be powered down in preparation for detachment of the print head from the ink system. That is to say, the electrical connectors may be arranged such that they disconnect before the fluid connectors. In some embodiments, the EHT connector may be arranged to disconnect first. Disconnecting of the electrical connectors may be achieved by the physical arrangement of the connectors (e.g. the electrical connectors may protrude more or less than other connectors). Disconnecting the EHT connector first may then cause other electrical lines and connections to be turned off. For example, the printhead may be arranged so that disconnecting the EHT connector prevents power being provided to other electrical components. In other embodiments, a controller may be arranged to prevent power being supplied to the other electrical lines and connectors if it identifies that the EHT connector has been disconnected.

The term “connection interface” encompasses a region of the printhead which comprises the fluid and electrical connectors, and is arranged for coupling of the connectors with complementary connectors of an ink system. The connectors of the connection interface may all be provided on a single face of the printhead. The connectors of the connection interface may be provided on two or more faces of the printhead. The connectors of the connection interface may be provided on faces of the printhead that are parallel but axially spaced. The fluid and electrical connectors of the connector interface may be “male” connectors configured to be received in a corresponding “female” connectors; or the fluid and electrical connectors of the connector interface may be “female” connectors configured to be received in a corresponding “male” connectors. The fluid connectors may comprise at least one male connector and at least one female connector, the electrical connectors may comprise at least one male connector and at least one female connector.

In some embodiments, the printhead and/or the printhead support arm may comprise a printhead controller, for example a touch screen. The printhead controller may be arranged to control actuation of components of the printhead and/or power supply to components of the printhead. The printhead controller may be in electrical communication with a controller of the continuous inkjet printer.

The term “cooperating guide features” encompasses alignment features or alignment means. The cooperating guide features help provide for a quick and easy connection or disconnection of the printhead to the ink system. Corresponding cooperating guide means may be provided on the printer, or on a second member or on a print head support member, without the need for any difficult alignment.

The guide features may form part of the printhead connection interface. The advantage of providing guide features, is that mis-alignment of the fluid and electrical connectors of the printhead with corresponding connectors of the ink system is mitigated. Thereby mitigating against damage to fluid and electrical connectors.

The printer may be configured to permit the printhead to be removed from printer, and for an alternative printhead to be connected to the printer, and for printing operations to commence within a period of around 2 minutes.

The alternative printhead may be the printhead that was removed from the printer.

Printing operations may commence within a period of around 3 minutes. Printing operations may commence within a period of between around 2 minutes to around 3 minutes. Printing operations may commence within a period of between around 1 minute to around 3 minutes. Printing operations may commence within a period of between around 1 minute to around 2 minutes.

The printer may be configured to permit the printhead to be removed from the printer in around 10 seconds or less from one or more safety conditions being satisfied.

Removing the printhead may take place in around 10 seconds. Removing of the printhead encompasses moving the printhead such that the plurality of fluid and plurality of electrical connectors are not engages with corresponding connectors of a printhead support arm connection interface, an umbilical or the like. Safety checks being satisfied encompass checking that EHT connector is off, that no power is supplied to the printhead and the like which may be printer specific. In some embodiments safety checks may not be required and the period of 10 seconds or less may be from when ejection of an ink jet of the printhead is stopped.

That is to say, within around 10 seconds or less a user may initiate removal of the printhead and the printhead be disconnected from the printhead support arm. In other words, within around 10 seconds the printhead can be removed so that it is not in mechanical, electrical, and fluid communication with the printhead support arm. Within the 10 seconds, the solenoid may move from an engaged configuration to a disengaged configuration, and the user may remove the printhead such that it is not in electrical or fluid communication with corresponding connectors.

A user may (i) in embodiments that comprise an electrical locking mechanism deactivate the electrical locking mechanism i.e. move a solenoid from an extended positon to a retracted position; and/or (ii) stop power supply to components of the printhead.

After removing the printhead from the printhead support arm, as user may (i) provide the alternative printhead, connect the printhead connection interface of the alternative printhead with the printhead support arm, optionally electrically lock the alternative printhead to the printhead support arm. Electrical power may then be provided to the components of the alternative printhead, and printing operations may commence. Printing operations may include ink being ejected from the printhead to be printed on a substrate. The time taken to provide the alternative printhead and commence printing operations may be around 50 seconds.

The continuous inkjet printer may comprise a controller. The controller may be arranged to check that before the printhead is disconnected there is no current supplied to components of the printhead.

This promotes safe removal of the printhead by mitigating a user from removing the printhead during printing operations.

That is to say, before disconnection of the printhead is permitted the controller is arranged to check that there is no current through components of the printhead, for example to a charge electrode and/or to deflection plates. It will be appreciated that if the printhead comprises electrical locking means, such as a solenoid, a current may still be applied to the solenoid so as to permit actuation of the solenoid.

A first guide feature may be provided on the printer and a second guide feature may be provided on the printhead.

In particular, the first guide feature may be provided on a printhead support, in particular on a printhead support arm.

Advantageously, mis-alignment of the fluid and electrical connectors of the printhead with corresponding connectors of the ink system is mitigated. Thereby mitigating against damage to fluid and electrical connectors. Furthermore, by providing a guide feature of the printer and a second guide feature on the printhead, the printhead must be correctly orientated, again mitigating against misalignment of corresponding connectors.

The guide features may comprise a guide rail or a guide groove.

The term “guide rail” encompasses one or more guide pins or rails for cooperating with one or more guide runners or grooves on a surface of the print head. The printer may comprise two guide rails and the print head may comprise two cooperating guide grooves. In particular, a print head support member may comprise the two guide rails. The one or more guide pins or rails and the one or more guide runners or grooves may be linear. The one or more guide pins or rails may readily slot into the one or more guide runners or grooves and are configured with a sliding relationship. As such, the one or more guide pins or rails may slide through the one or more guide runners or grooves to provide for easy connection/disconnection and alignment of the print head and second support member. One or more suitable stops may be provided in the one or more guide runners or grooves so that the print head is forced to stop sliding when the various electrical and fluid connectors and the complementary connectors connect. The print head may instead comprise the one or more guide pins or rails and the second support member may comprise the one or more guide runners or grooves. Alternatively, the alignment means may comprise any other suitable mechanisms that may also have other types of mechanical relationship, for example the print head may roll into place on the second support member.

The continuous inkjet printer may further comprise a printhead support for supporting the printhead, wherein the cooperating guide features may be configured to allow only generally linear movement of the printhead relative to the printhead support

The printhead support may be a printhead support arm. The printhead support arm may comprise a plurality of fluid and electrical connectors for connection to corresponding connectors of the printhead. The printhead support arm may be rigidly attached to the continuous inkjet printer, or may be provided at the end of an umbilical, or may partly define a rotatable and/or tillable support arm as defined herein. That is to say, when connecting and disconnecting the printhead, in particular the electrical connectors and the fluid connectors from the corresponding connectors of the ink system. The guide rails are configured to allow only linear motion of the printhead. In doing so, and lateral and orthogonal movement of the printhead is generally prohibited. This is particularly advantageous at the point of connection and disconnection of the printhead, as any non-linear connection of disconnection of the fluid and electrical connectors could result in damage to the connectors. Additionally, it also allows from rapid connection and disconnection of the printhead, as at the point of connection the corresponding electrical and fluid connectors are aligned. Therefore, the moment required by a user is restricted to one dimensional movement.

The guide features may extend along over 75% a length of the printhead.

The guide features may extend along over between 75% and 95% of the printhead.

The length of the printhead is to be understood as the length of the printhead which the guide features are provided on. Because the guide features extend over 75% of the length of the printhead, this further reduces any lateral or orthogonal movement that may occur at the point of engaging the corresponding electrical and fluid connectors.

The guide features may comprise a first guide region configured to provide coarse guidance and a second guide region configured to provide fine guidance and a tapered region between the first guide region and the second guide region.

Providing a first coarse guidance aids in quick connection of the printhead to the ink system. This is because a user who is connecting a printhead to the ink system does not need to spend time precisely aligning the guide features provided on the printhead with corresponding guide features on the printer. Instead, a user may generally align the guide features of the printhead with the corresponding guide features of the printer and as the user moves the plurality of fluid and electrical connectors towards the corresponding connectors, first guide region allows the user to guide the printhead towards the second guide region, where the second guide region ensures that the fluid and electrical connectors of the printhead will align with the corresponding connectors of the printer.

In addition to providing alignment of corresponding connectors between the printhead and printer, the guide features may also mitigate against damage to the connectors by ensuring that the printhead is always provided in the correct orientation, and if in the incorrect orientation, the guide features causing an offset between the connectors on the print head and corresponding connectors of the ink system, such that a user cannot inadvertently attempt to connect two non-corresponding connectors.

The printhead connection interface may comprise a self-coupling mechanical interlock.

The term “self-coupling mechanical interlock” encompasses a self-locking mechanical coupling assembly, which may be integrally formed with the printhead. A self-coupling mechanical interlock differs from other mechanical fastenings such as threaded screws and bolts, in that it does not require securing or tightening in order to secure the locking assembly. A self-coupling mechanical interlock may include a latch and body mechanism, the body may be a protruding barb, or a clamping arm and a clamping rod. By way of example, a latch may be coupled to a wall of the printhead or to a wall of the printer, and a corresponding barb may be coupled to a wall of the printer or printhead respectively. The latch may comprise a key-hole configured to receive and engage with the barb. The latch and/or the barb may be biased. Any other suitable type of interlock may be provided. A mechanical interlock of these types simple, and has a high tolerance with low creep engagement, thus promoting quick engagement and release of the interlock.

By providing a mechanical interlock, the printhead may be quickly mechanically secured to the ink system, and likewise may be quickly released from the ink system. In addition, the provision of a mechanical interlock mitigates against the plurality of fluid and/or electrical connectors from becoming dislodged or disconnected during use. This is particularly important in relation to the electrical connectors, where at least one of the electrical connectors may be a high voltage electrical connector and/or one of the fluid connectors may be a high pressure fluid connector. The provision of a quick mechanical release mechanism in the form of a mechanical interlock is advantageous as downtime in printing is reduced when removing and replacing a printhead. The printhead may be removed from the ink system in a single motion.

The mechanical interlock may be configured to prevent removal of the printhead unless a safety condition is satisfied.

That is to say the mechanical interlock may not be released until a safety condition is satisfied. By not being able to release the mechanical interlock until a safety condition is satisfied prevents the printhead being removed or disconnected from the ink system.

This may prevent the printhead from being mistakenly detached from the second support member whilst printing, in which case printer fluid may inadvertently come into contact with the electrical connectors on the print head or second support member.

The safety condition that is to be satisfied may include at least one of the following:
There is no transfer of power between the plurality of electrical connectors;
There is no voltage drop across the plurality of electrical connectors;
There is no passage of fluid between the fluid connectors.

The printhead connection interface may comprise a release trigger, configured to initiate a release sequence.

The term release trigger encompasses a release button, a touch screen, or may be implemented by a feature of a printhead such as a push button. By providing a release trigger to initiate a release sequence, safe removal of the printhead can occur. For example, the actuation of the release trigger may cause all power supply to electrical components of the printhead to be terminated before the printhead can be disconnected from the printhead support arm.

In other embodiments, the release trigger may not form part of the printhead connection interface.

The release sequence may comprise determining if the safety condition is satisfied and releasing the mechanical interlock only when the safety condition is satisfied.

The first step of the release sequence may be to shut down the ink jet. In particular, to stop ink being ejected from the nozzle of the printhead. Shutting down the inkjet may be initiated by a user. For example, a user may engage the release trigger which initiates the release sequence. Initiation of the release trigger may cause shut down of the inkjet. However, shut down of the ink jet may be caused, for example if one of the electrical components of the printhead or the printer trips. e.g. if the extra high tension electrical connector trips. The printer may alert the user if the ink jet is stopped due to a component or electrical failure. Shutting down of the ink jet may initiate the release sequence.

Following shut down of the ink jet. One or more safety checks may be completed. Once the safety checks are completed, and hence one or more safety conditions are satisfied removal of the printhead may be permitted. Possible safety checks include but are not limited to:
checking that an EHT is off. This may be implemented by a controller checking that no power is supplied to the printhead via the EHT connector.
checking that power supply to the electrical components of the printhead is off (save as for the solenoid, if a solenoid is present).
Checking that an ink pump of the printer is off.
Checking that a solvent pump of the printer is off.
Checking that a gutter pump of the printer is off.
Checking that a pressure transducer is less than a predetermined pressure. In particular, the pressure may be less than around 0.1 bar.
Check that the fluid control valves are closed.

In embodiments which comprise an electrical lock, such as a solenoid. Unlocking of the electrical lock may be prohibited until the safety conditions are satisfied.

The continuous inkjet printer may comprise an electrical lock configured to electrically lock the self-coupling mechanical interlock. The term electrical lock encompasses a solenoid, in particular a solenoid release actuator. The printhead may comprise the electrical lock. The electrical lock may be arranged to prevent disconnection of the mechanical interlock during operation of the printer. By way of example, a solenoid release actuator may be actuated to engage with the mechanical interlock so as to prevent de-coupling of the mechanical interlock, and the mechanical interlock may only be able to decouple and hence allow removal of the printhead when the solenoid release actuator is not engage with the mechanical interlock.

The self-coupling mechanical interlock may comprise a latch for engagement with a corresponding locking body of the continuous inkjet printer. By way of example, a latch may be coupled to a wall of the printhead or to a wall of the printer, and a corresponding locking body, such as a barb may be coupled to a wall of the printer or printhead respectively. The latch may comprise a key-hole configured to receive and engage with the barb. The latch and/or the barb may be biased. Any other suitable type of interlock may be provided. A self-coupling mechanical interlock of these types is simple, and has a high tolerance with low creep engagement, thus promoting quick engagement and release of the interlock.

The self-coupling mechanical interlock may be arranged to provide quick and safe release of the printhead from the ink system.

That is to say the printhead may be quickly disconnected from the printer. In particular, the printhead may be quickly disconnected from an umbilical or from a printhead support arm. The arrangement to allow quick disconnection, may include a user or operator needing to only release the mechanical interlock, for example by actuating a mechanical push button, and/or an electronic switch, when then allows the user to disconnect the printhead in a single movement (e.g. pulling the printhead away from the printer). The self-coupling mechanical interlock may provide safe release of the printhead, as the self-coupling mechanical interlock may be arranged so that it cannot be de-coupled from the ink system without a user input, for example a user actuating a push button. This is advantageous as downtime in printing is reduced when removing and replacing a printhead. The printhead may be removed from the ink system in a single motion.

The self-coupling mechanical interlock may be engaged and released without use of a tool. That is to say, a user may be able to engage and release the self-coupling mechanical interlock using only their hands and without the need to use a tool such as a screwdriver, wrench etc. In particular, a user may be able to engage and release the self-coupling mechanical interlock without using any rotational movement (i.e. the user is not required to unscrew or un-twist any mechanical securing feature).

The disengagement and engagement of the mechanical interlock without a tool further reduces printing downtime when removing and replacing a printhead, and may mitigate against the need to for a specialised service technician to remove and replace the printhead.

The self-coupling mechanical interlock may be configured to engage only when the plurality of fluid connectors and the plurality of electrical connectors are engaged with their corresponding connectors of the ink system. This is advantageous, since the self-coupling mechanical interlock ensures engagement of the plurality of fluid connectors and the plurality electrical connectors with the corresponding connectors of the ink system.

The continuous inkjet printer may further comprise a controller, and wherein at least one of the plurality of fluid connectors, and/or at least one of the plurality of electrical connectors may comprise a sensor, and the controller may operable to receive signals from the sensor.

The signals that the controller receives may be indicative of a status of the connector that is associated with the sensor. By way of example, the sensor may be able to send a signal that is indicative of whether a valve of a fluid connector is open or closed. Likewise, the sensor may be able to send a signal that is indicative of whether electrical power is passing through the electrical connector. The continuous inkjet printer may comprise a plurality of sensors. Based upon the signals received by the controller, the controller may be configured to determine if a safety condition is satisfied. The controller may be configured to permit disconnection of the printhead when a safety condition is satisfied. In particular, the controller may be able to allow the de-coupling of the self-coupling mechanical interlock when a safety condition is satisfied; or when a pre-determined signal or set of signals is received by the controller. By not being able to release the mechanical interlock and hence disengage the plurality of fluid connectors and electrical connectors until the safety condition is satisfied mitigates against a user who may be trying to remove the printhead from contacting a live voltage source or connector.

A distal end of the plurality of fluid connectors may be offset from a distal end of the plurality of electrical connectors.

That is to say, the distal ends of the plurality of the fluid connectors do not lie in the same plane as the distal ends of the plurality of electrical connectors. This mitigates against fluid, in particular ink or solvent, from the fluid connectors dripping onto and damaging the electrical connectors.

Further, providing the fluid and electrical connectors on a connection interface, preferably, on a single face of a connection interface, or on faces of the connection interface that are parallel but axially spaced improves forming secure connections with complementary connectors of the ink system.

At least one of the plurality of fluid connectors may comprise a self-sealing fluid valve for preventing leaking of printing fluid when the printhead is removed.

The printhead may be configured so that ink (or other fluid) does not leak out on disconnection of the print head from the ink system. At least one of the plurality of fluid connectors may comprise a self sealing valve.

The continuous inkjet printer may comprise a self-sealing valve assembly for the complementary connectors that connect to the fluid connectors. Having the assembly outside of the print head may allow for a smaller size for the print head. However, the assembly could otherwise be provided in the print head. The assembly may be configured to automatically open when the print head is connected to the second ink system and to automatically seal closed when disconnected from the ink system. Being open may mean that fluid can flow along a fluid flow path between the ink system and the printhead. Being closed may mean that fluid is prevented from flowing from out of the ink system, and so the fluid path is broken. The assembly may minimise or eliminate fluid leakage upon removal or disconnection of the print head from the ink system.

The printer may be configured to permit the printhead to be removed from the printer and connected to the printer without the use of any tools.

To be put another way, a user or operator of the printer may be able to connect a printhead to the printer using only their hands, and similarly, may be able to remove the printhead from the printer using only their hands. Because tools are not needed to, for example, release fasteners, the printhead may be quickly connected to and removed from the printer. Accordingly, down time of the printer is reduced when removing an replacing a printhead.

The printer may comprise a printhead support coupled to the ink system, the printhead connection interface may be supported by components of the printhead support and the printhead.

The printhead support may be referred to as a printhead support member, or as a printhead support arm. That is to say, the print head may be indirectly connected to the ink system via one or more interposing components, such as a print head support arm (e.g. a tiltable portion, or non-tiltable portion, of a print head support arm). The print head support arm may be pivotally connected to the printer body by a rotatable coupling. The rotatable coupling may be configured to permit the print head to rotate relative to the printer body about a print head rotation axis. Alternatively, the printhead support arm may be rigidly fixed to a printer, or may be mounted in a printing location. When the printhead support arm is mounted at a printing location, the printhead support arm may be connected to an umbilical.

The printhead support may be rotatably coupled to printer.

The printhead support may be pivotally connected to the printer body by a rotatable coupling. The rotatable coupling may be configured to permit the print head support and hence the printhead to rotate relative to the ink system about a print head rotation axis.

The continuous inkjet printer may comprise a product detection sensor to sense the position of the external substrate.

The product detection sensor may comprise a sensor beam. The product detection sensor may comprise one or more lenses. The product detection sensor may be arranged to detect the product/substrate to which ink droplets are to be printed onto and may be able to sense the direction and speed of the product. The sensor may be a standard sensor, for example a proximity sensor. The product detection sensor may comprise a photoelectric sensor (also known as a photocell pair sensor), which may use infrared radiation, or may comprise a pin hole sensor.

The printhead support may comprise the product detection sensor. The product detection sensor may comprise a plurality of detection sensors. The product detection sensor may comprise two sensors. In embodiments where the product detection sensor comprises two sensors, one sensor may be provided at either side of the location where ink droplets are ejected from the printhead.

The product detection sensor may be set back from the location or aperture at which ink droplets are ejected from the printhead. This mitigates against ink droplets splattering on the sensor.

The product detection sensor may be positioned less than around 5 millimetres from the gutter. Preferably, the detection area, i.e. the area that the product detection sensor 1305 covers, should be less than 5 mm below the gutter. This is so that the product detection sensor 1305 can sense in the area where printing is required.

The printhead may comprise a removable cover.

The removable cover may be removable from the printhead only when the printhead is not connected to the ink system.

The removable cover prevents access to components of the printhead during operation, this has the advantage of protecting the features of the printhead from external factors and environmental conditions such as moisture, dust, foreign particulates and extreme temperatures; but also the advantage of protecting an operator or a third person from contacting components of the printhead which during operation may have a high voltage (i.e. a voltage that could cause serious injury or death to a person) from contacting said components.

By the cover only being able to be removed when the printhead is not connected to the system prevents a user or operator from contacting the high voltage components during a printing operation, thus increasing the safety of the printer.

By the cover only being removable when the printhead is not connected to the ink system, i.e. when there is no fluid or electrical connection between the printhead and ink system promotes safe use of the printhead since no high voltage parts of the printhead can be contacted during operation. Furthermore, this allows a single printhead to be quickly and safely removed and replaced, rather than requiring the removable cover to be removed in order to access for example a printhead release screw to then remove the printhead.

The removable cover may prevent access to the droplet generator, the at least one electrode and the gutter when covering the printhead.

In other words, when the removable cover is removed at least one of the droplet generator, the at least one electrode, and the gutter may be accessed.

Providing a removable cover allows ease of access to the components of the printhead, in particular to at least one of the droplet generator, the at least one electrode, and the gutter can be accessed. This allows easy access to printhead components for servicing, maintenance and replacement and replacement of components. Yet the removable cover protects the components of the printhead from external factors and environmental conditions such as moisture, dust, foreign particulates and extreme temperatures, in particular during printing operations.

When the printhead cover is removed the droplet generator, the at least one electrode and the gutter may all be able to be accessed by a user.

The removable cover may be removed from the printhead without a tool. That is to say, a user may be able to remove the removable using only their hands and without the need to use a tool such as a screwdriver, wrench etc.

The removable cover may comprise clips which cooperate with grooves in the printhead in a ‘pinch and withdraw’ type mechanism. The clips may each have a protrusion that cooperates with, and/or abuts, a step, or stepped portion, within their respective groove such that when the clips are fully inserted into the grooves, the clips may not be pulled out of the grooves with a purely linear motion. The user may need to bias (e.g. ‘pinch’) the clips so that the protrusion can overcome the stepped portion and can then be pulled out of the groove with a purely linear motion. As such the removable cover may be removed from the printhead using a “pinch and withdraw” type mechanism.

In other embodiments, the removable cover may only be removed with use of a tool. For example, the removable cover may only be removed if an unlocking “key” is inserted into a locking mechanism of the removable. The advantage of requiring a tool to in order to remove the cover is that it mitigates against unauthorised users from removing the cover, and thereby mitigates against an unauthorised user damaging the components of the printhead.

Features of the seventh aspect may be combined with features of the eighth aspect. Features of the eighth aspect may be combined with features of the seventh aspect.

According to a ninth aspect there is provided a printhead for a continuous inkjet printer, the printhead comprising: a droplet generator configured to generate and eject a stream of ink droplets for printing; at least one electrode configured to steer the stream of ink droplets; and a gutter configured to receive droplets of ink which are not used for printing, wherein the printhead is releasably connectable to an ink system of a continuous inkjet system by a printhead connection interface, the printhead connection interface comprising a plurality of electrical connectors, and a plurality of fluid connectors, and the printhead is configured to be removed from a printer, and for an alternative printhead to be connected to the printer, and for printing operations to commence within a period of around 2 minutes.

The alternative printhead may be the printhead that was removed from the printer.

Printing operations may commence within a period of around 3 minutes. Printing operations may commence within a period of between around 2 minutes to around 3 minutes. Printing operations may commence within a period of between around 1 minute to around 3 minutes. Printing operations may commence within a period of between around 1 minute to around 2 minutes.

The printhead connection interface may comprise cooperating guide features configured to guide the printhead into a connected configuration from a disconnected configuration.

According to a tenth aspect there is provided a printhead for a continuous inkjet printer, the printhead comprising: a droplet generator configured to generate and eject a stream of ink droplets for printing; at least one electrode configured to steer the stream of ink droplets; and a gutter configured to receive droplets of ink which are not used for printing; and wherein the printhead is releasably connectable to an ink system of a continuous inkjet system by a printhead connection interface, the printhead connection interface comprising a plurality of electrical connectors, a plurality of fluid connectors, and cooperating guide features configured to guide the printhead into a connected configuration from a disconnected configuration.

The printhead may be configured to be removed from a printer, and for an alternative printhead to be connected to the printer, and for printing operations to commence within a period of around 2 minutes

The printhead may be configured to be removed from the printer in around 10 seconds.

The printhead may comprise a first guide feature, the first guide feature may be complementary to a guide feature of a printer.

The guide features may comprise a guide rail or a guide groove.

The guide features may extend along over 75% a length of the printhead.

The length of the printhead is to be understood as the length of the printhead which the guide features are provided on. Because the guide features extend over 75% of the length of the printhead, this further reduces any lateral or orthogonal movement that may occur at the point of engaging the corresponding electrical and fluid connectors.

The guide features may comprise a first guide region configured to provide coarse guidance and a second guide region configured to provide fine guidance and a tapered region between the first guide region and the second guide region.

The printhead connection interface may comprise a self-coupling mechanical interlock.

The printhead may comprise a removable cover and wherein the removable cover may be removable from the printhead only when the printhead is not connected to the ink system.

Features of the ninth aspect may be combined with features of the seventh, eighth, or tenth aspect. Features of the tenth aspect may be combined with features of the seventh, eighth, or ninth aspect.

According to an eleventh aspect there is provided a method of operating a continuous inkjet printer for printing onto an external substrate that moves past the printer, the printer comprising a printhead and an ink system for storing ink and supplying ink to the printhead, wherein the printhead is releasably connectable to the ink system; the printhead comprising: a droplet generator configured to generate and eject a stream of ink droplets for printing; at least one electrode configured to steer the stream of ink droplets; a gutter configured to receive droplets of ink which are not used for printing; wherein the printhead is releasably connectable to the ink system by a printhead connection interface, the printhead connection interface comprising a plurality of fluid connectors, and a plurality of electrical connectors; the method comprising, within a period of around 2 minutes: removing the printhead from the printer; providing an alternative printhead; connecting the plurality of fluid connectors of the alternative printhead to corresponding connections of the printer; connecting the plurality of electrical connectors of the alternative printhead to corresponding connections of the printer; resuming printing operations.

The printhead connection interface may comprise cooperating guide features configured to guide the printhead into a connected configuration from a disconnected configuration, and the method may comprise: aligning the cooperating guide features; connecting the plurality of fluid connectors to corresponding connections of the printer; connecting the plurality of electrical connectors to corresponding connections of the printer.

According to a twelfth aspect there is provided a method of operating a continuous inkjet printer for printing onto an external substrate that moves past the printer, the printer comprising a printhead and an ink system for storing ink and supplying ink to the printhead, wherein the printhead is releasably connectable to the ink system; the printhead comprising: a droplet generator configured to generate and eject a stream of ink droplets for printing; at least one electrode configured to steer the stream of ink droplets; a gutter configured to receive droplets of ink which are not used for printing; wherein the printhead is releasably connectable to the ink system by a printhead connection interface, the printhead connection interface comprising a plurality of fluid connectors, a plurality of electrical connectors, and cooperating guide features configured to guide the printhead into a connected configuration from a disconnected configuration; the method comprising: aligning the cooperating guide features; connecting the plurality of fluid connectors to corresponding connections of the printer; connecting the plurality of electrical connectors to corresponding connections of the printer.

The method may comprise, within a period of around 2 minutes: removing the printhead from the printer; providing an alternative printhead; connecting the plurality of fluid connectors of the alternative printhead to corresponding connections of the printer; connecting the plurality of electrical connectors of the alternative printhead to corresponding connections of the printer; resuming printing operations.

Removing the printhead may take place within a period of around 10 seconds or less from one or more safety conditions being satisfied.

Removing the printhead may take place in around 10 seconds. Removing of the printhead encompasses moving the printhead such that the plurality of fluid and plurality of electrical connectors are not engages with corresponding connectors of a printhead support arm connection interface, an umbilical or the like. Safety checks being satisfied encompass checking that EHT connector is off, that no power is supplied to the printhead and the like which may be printer specific. In some embodiments safety checks may not be required and the period of 10 seconds or less may be from when ejection of an ink jet of the printhead is stopped.

Prior to removing the printhead, the method may include checking no current is supplied to the components of the printhead using a controller.

Removing the printhead may comprise sliding the printhead away from a printhead support member.

Providing an alternative printhead may comprise sliding the alternative printhead towards a printhead support member.

The printhead connection interface may comprise a release trigger, and the method may comprise: actuating the release trigger; initiating a printhead release sequence.

The printhead release sequence may include:
shutting down the ink jet
checking that at least on safety condition is satisfied
disengaging the solenoid
removing the printhead.

The step of checking that the at least one safety condition is satisfied may be omitted in some embodiments, or may be manually overridden by a user.

The step of disengaging the solenoid may not be present in embodiments which do not comprise a solenoid.

The printhead connection interface may comprises a self-coupling mechanical interlock, the method may comprise engaging the self-coupling mechanical interlock to prevent removal of the printhead.

The method may comprise satisfying a safety condition; releasing the mechanical interlock to allow removal of the printhead.

A controller may be used to determine that the safety condition is satisfied.

The printhead may further comprise a removable cover, and the method may comprise removing the removable cover when the printhead is not connected to the ink system.

Removing the removable cover may include pinching and withdrawing the removable cover.

The method may further comprise: satisfying a safety condition; removing the removable cover after the safety condition is satisfied.

A controller may be used to determine that the safety condition is satisfied.

Features of the eleventh aspect may be combined with features of the seventh to tenth aspects and the twelfth aspect. Features of the twelfth aspect may be combined with features of the seventh to eleventh aspects.

Features of the first aspect may be combined with features of the second to twelfth aspects. Features of the second aspect may be combined with features of the first aspect and the third to twelfth aspects. Features of the third aspect may be combined with features of the first aspect, the second aspect, and the fourth to twelfth aspects. Features of the fourth aspect may be combined with features of the first to third aspects, and the fifth to twelfth aspects. Features of the fifth aspect may be combined with features of the first to fourth aspects, and the sixth to twelfth aspects. Features of the sixth aspect may be combined with features of the first to fifth aspects, and the seventh to twelfth aspects.

Features of the seventh aspect may be combined with features of the first to sixth aspects, and the eighth to twelfth aspects. Features of the eighth aspect may be combined with features of the first to seventh aspects, and the ninth to twelfth aspects. Features of the ninth aspect may be combined with features of the first to eighth aspects, and the tenth to twelfth aspects. Features of the tenth aspect may be combined with features of the first to ninth aspects, and the eleventh and twelfth aspects. Features of the eleventh aspect may be combined with features of the first to tenth aspects, and the twelfth aspect. Features of the twelfth aspect may be combined with features of the first to eleventh aspects.

The optional and/or preferred features for each aspect of the invention set out herein are also applicable to any other aspects of the invention.

Specific embodiments of the present invention will now be described, by way of example only, with reference to the accompanying drawings in which:

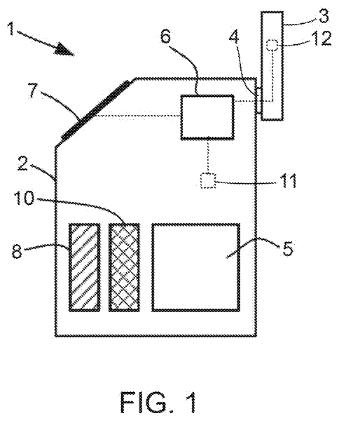

FIG. 1 is a schematic illustration of a continuous inkjet (CIJ) printer in accordance with an embodiment of the invention;

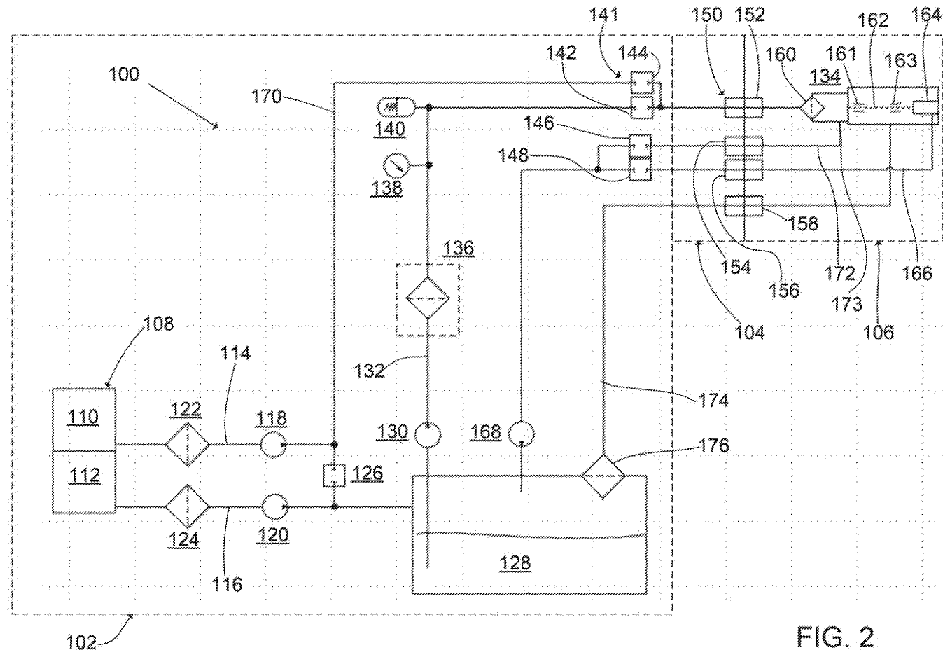

FIG. 2 is a schematic illustration of a fluid circuit of a CIJ printer in accordance with an embodiment of the invention;

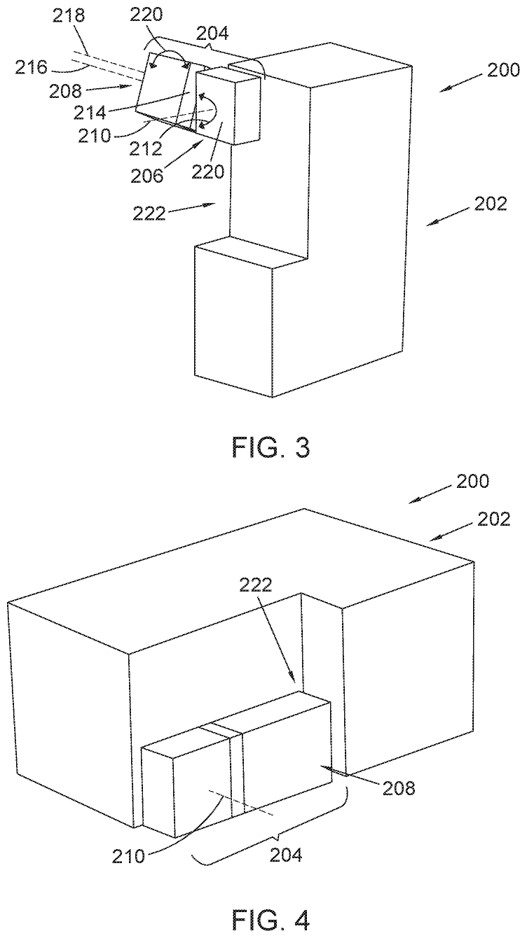

FIG. 3 is a perspective view of a CIJ printer, in a deployed configuration, in accordance with an embodiment of the invention;

FIG. 4 is a perspective view of the CIJ printer shown in FIG. 3, in a stowed configuration;

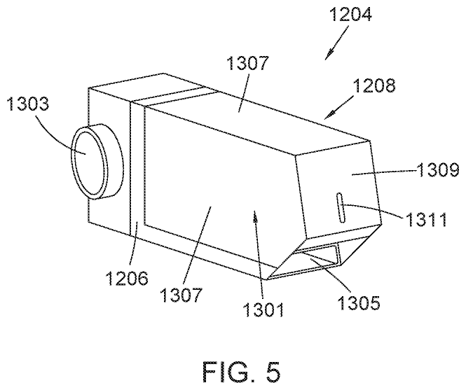

FIG. 5 is a perspective view of a print arm of a continuous inkjet printer in accordance with an embodiment of the invention;

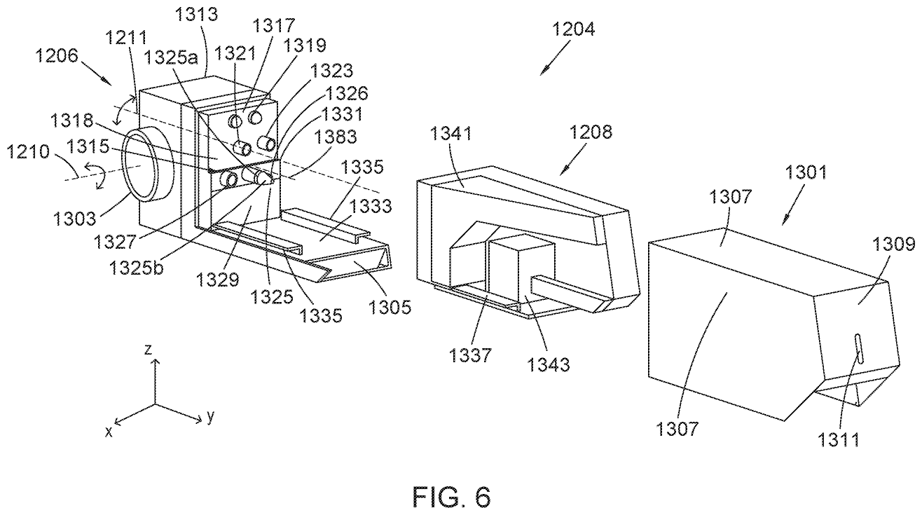

FIG. 6 is an exploded view of the print arm shown in FIG. 5;

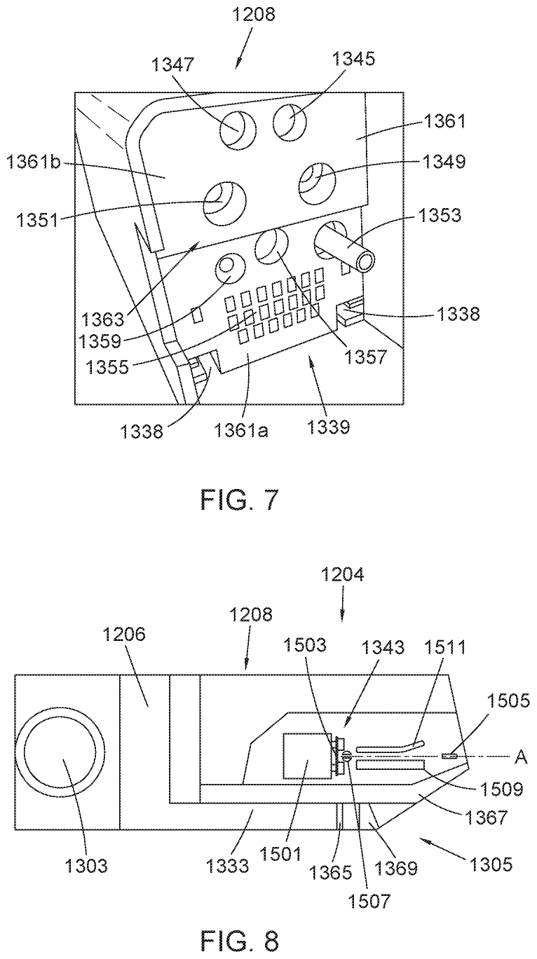

FIG. 7 is a perspective end view of the printhead of FIG. 5 and FIG. 6 showing the connection interface;

FIG. 8 is a side view of the print arm shown in FIGS. 5 and 6, with a partial cut-through to show internal components of the printhead;

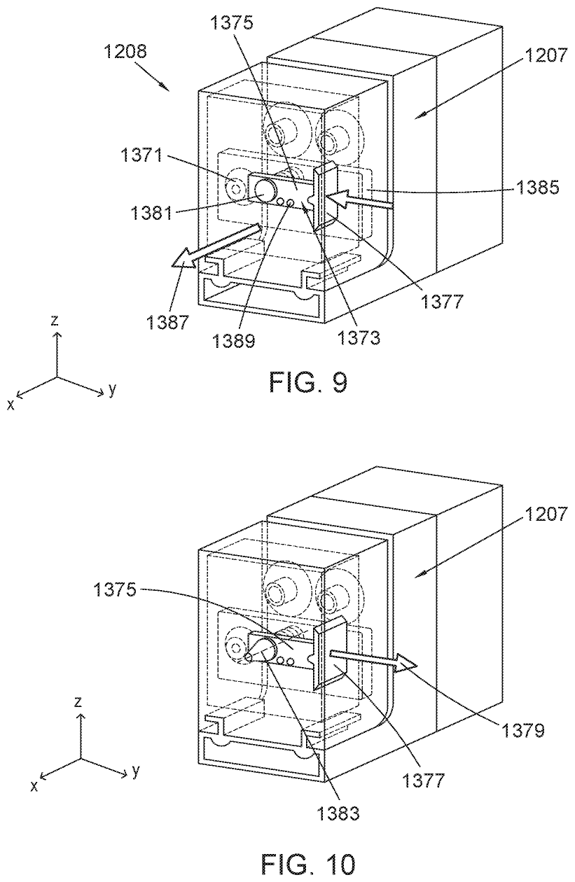

FIG. 9 is a perspective cut through view of the printhead and printhead support arm according to FIGS. 5 to 8, comprising a self-coupling mechanical interlock in an unlatched state;

FIG. 10 is a perspective cut through view of the printhead and printhead support arm of FIG. 9, where the self-coupling mechanical interlock is in a latched state;

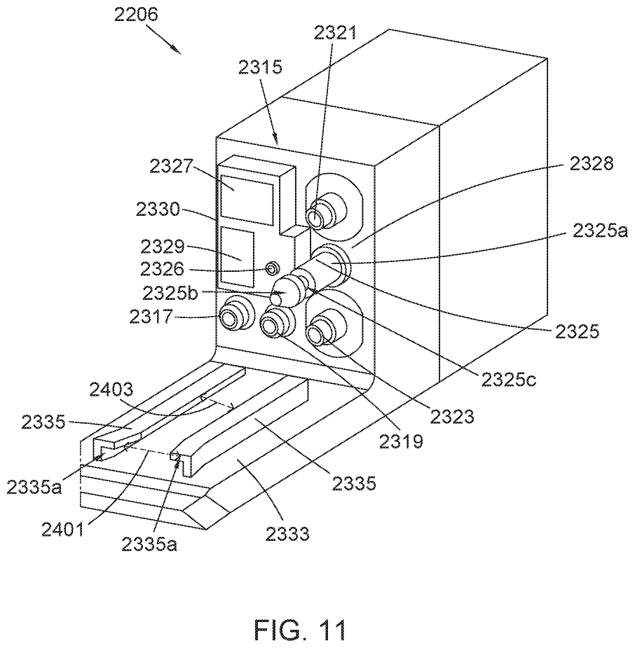

FIG. 11 is a perspective end view of a model of a printhead support arm in accordance with an embodiment of the invention;

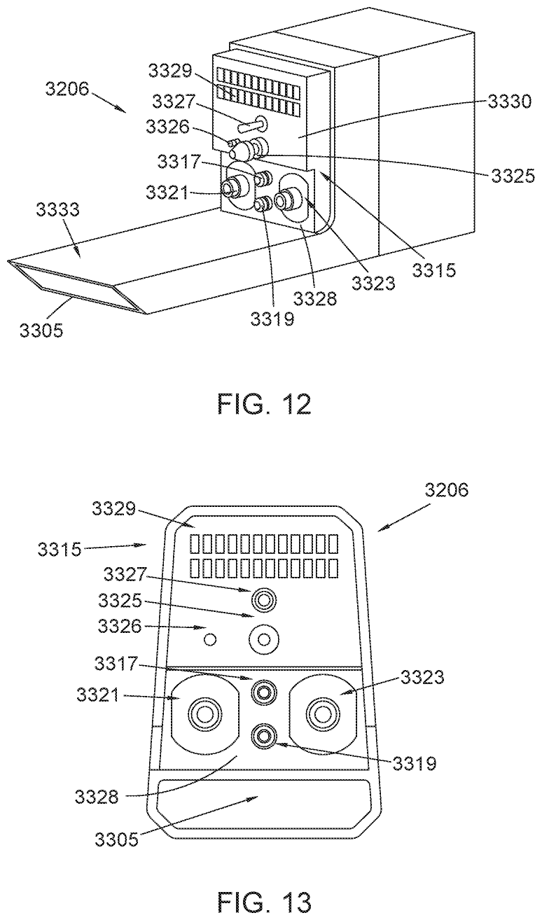

FIG. 12 is a perspective end view of a model of a printhead support arm in accordance with an embodiment of the invention;

FIG. 13 is an end view of the printhead support arm of FIG. 11;

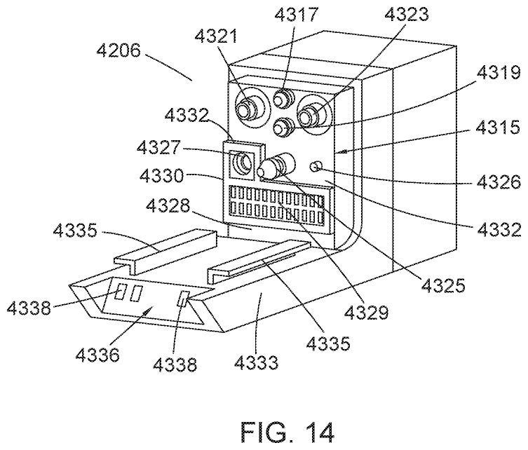

FIG. 14 is a perspective end view of a model of a printhead support arm in accordance with an embodiment of the invention;

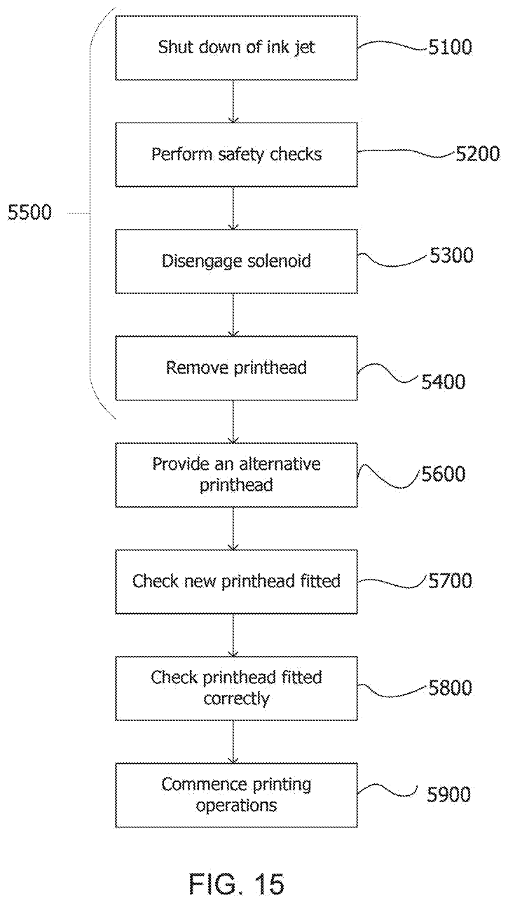

FIG. 15 is a schematic illustration of a method of removing and replacing a printhead in accordance with an embodiment of the invention following a release sequence.

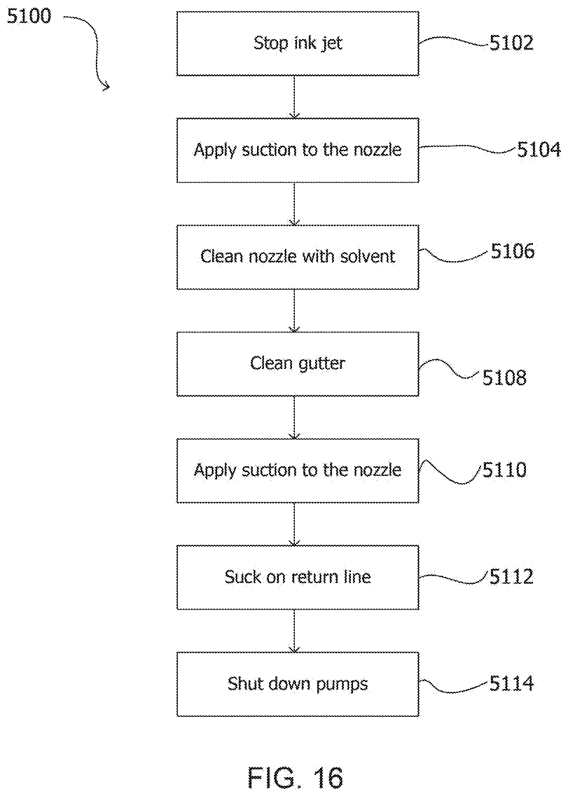

FIG. 16, is a flow chart showing the steps that may occur when shutting down an ink jet prior to removing the printhead.

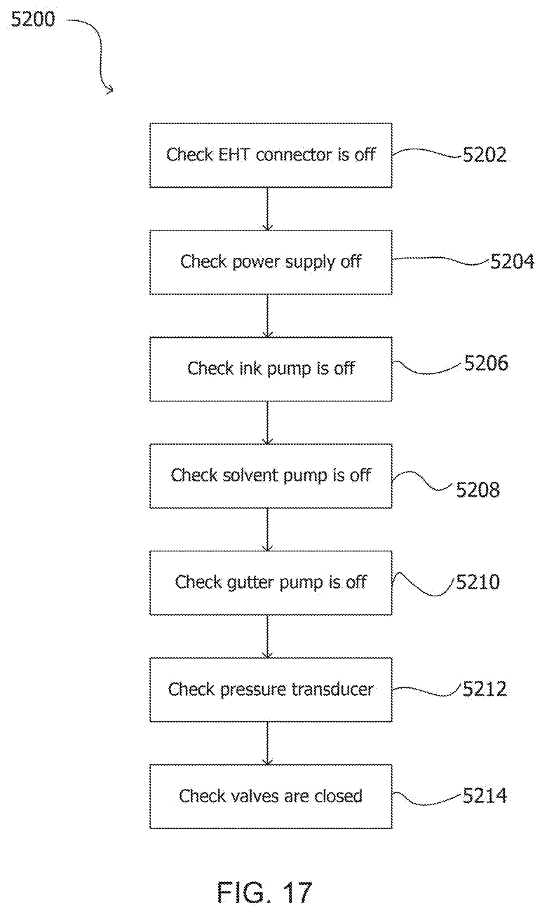

FIG. 17 is a flow chart showing the steps of checking that safety conditions are satisfied.

FIG. 1 schematically illustrates a continuous inkjet (CIJ) printer 1 according to an embodiment of the invention. The printer 1 comprises a printer body 2 and a print head 3. The print head 3 is pivotally connected to the printer body 2 via a rotatable coupling 4. The printer body 2 houses an ink system 5 and a printer controller 6. The printer body 2 also has an interface 7 (e.g. a display, keypad, and/or touch screen) for use by an operator.

The print head 3 is arranged to print on a substrate provided adjacent to the print head 3. The printer 1 comprises two connectors (e.g. male connectors) for engagement with respective fluid compartments of a cartridge or cartridges, optionally via a corresponding connector (e.g. female connector) of the compartment or cartridge. In particular, the printer 1 comprises a connector for engagement with an ink compartment 8 and a connector for engagement with a solvent compartment 10. The connections typically each comprise a fluid port arranged to connect to a fluid pathway within the printer 1 to allow fluid to flow between the compartments 8, 10 and other parts of the inkjet printer 1, such as the ink system 5 and the print head 3.

In operation, ink from the ink compartment 8 and solvent from the solvent compartment can be mixed within the ink system 5 to generate printing ink of a desired viscosity that is suitable for use in printing. This ink is supplied to the print head 3 and unused ink is returned from the print head 3 to the ink system 5. When unused ink is returned to the ink system 5 from the print head 3, air may be drawn in with ink from a gutter of the print head 3. The air may then become saturated with solvent in the gutter line.

In operation, ink is delivered under pressure from the ink system 5 to the print head 3 and recycled back via flexible tubes which are bundled together with other fluid tubes and electrical wires (not shown). In order to maintain correct consistency of the ink, the ink system 5 may be operable to mix ink removed from the ink compartment 8 with solvent removed from the solvent compartment 10 and to mix them together to obtain an ink having the correct viscosity and/or density for a particular printing application.

The printer 1 further comprises a first position detector 11. The first position detector 11 is disposed in the printer body 2. The first position detector 11 is configured to detect the position (e.g. orientation) of the printer body 2 (e.g. vertical, horizontal etc.) The printer 1 further comprises a second position detector 12. The second position detector 12 is disposed in the print head 3. The second position detector 12 is configured to detect the position (e.g. orientation) of the print head 3 (e.g. the rotational position thereof).

Each of the first and second position detectors 11, 12 are connected to the printer controller 6. The printer controller 6 is also connected to the interface 7.

FIG. 2 is a schematic illustration of a fluid circuit 100. The fluid circuit 100 forms part of a CIJ printer in accordance with embodiments of the invention.

Dashed lines are used in FIG. 2 to indicate the boundaries of various components, shown in the fluid circuit 100, which form part of a CIJ printer (e.g. the printer 1 of FIG. 1) in accordance with embodiments of the invention. A first box 102 indicates components housed within a printer body (e.g. printer body 2 of FIG. 1). A second box 104 indicates components mounted in a print head support arm. A third box 106 indicates components mounted within the print head (e.g. print head 3 of FIG. 1). The combination of second and third boxes 104, 106 may be said to define a print arm. The components bound by at least the first box 102 may be described as an ink system.

In some embodiments, and as will be described in detail below, the print head support arm (e.g. components bound by 104) may be rotatably connected to the printer body (e.g. components bound by 102). The print head (e.g. components bound by 106) may be removably connected to the print head support arm. The print head may be tiltable with respect to the print head support arm. In other embodiments, the print head support arm may be omitted, and the print head be coupled to the printer body via an umbilical.

In the illustrated embodiment, the fluid circuit 100 comprises a single, replaceable cartridge 108. The cartridge 108 contains both solvent and ink used in the printing process. Unlike prior art arrangements, the fluid circuit 100 comprises the single cartridge 108 as opposed to separate cartridges for solvent and ink respectively. The cartridge 108 is split into a plurality of different compartments (e.g. may have only two compartments). The cartridge 108 in the illustrated embodiment is split into a pair of compartments: a solvent compartment 110 and an ink compartment 112. As suggested by the names, the individual compartments contain (only) solvent and (only) ink respectively. Compartments 110, 112 may otherwise be referred to as tanks. The single cartridge 108 is an optional feature of the present invention and, in other embodiments, a plurality of cartridges may otherwise be incorporated. However, incorporation of a single cartridge is beneficial for reasons of reduced waste and a reduced maintenance requirement.

Downstream of the cartridge 108, a solvent supply line 114 and ink supply line 116 are provided. The solvent and ink supply lines 114, 116 are separate conduits which can be selectively placed in fluid communication with one another if desired. Each of the solvent and ink supply lines 114, 116 connects the cartridge 108, specifically the solvent and ink compartments 110, 112 thereof, to a solvent refill pump 118 and an ink refill pump 120. Each of the solvent refill pump 118 and ink refill pump 120 can be used to selectively pump solvent and ink from the solvent and ink compartments 110, 112 respectively of the cartridge 108. The solvent and ink refill pumps 118, 120 are diaphragm pumps in the illustrated embodiment, but other varieties of pump could otherwise be used.

Each of the solvent and ink compartments 110, 112 of the cartridge 108 are removably connectable to respective solvent and ink supply lines 114, 116. This allows for periodic replacement of the cartridge 108 when either or both of the ink and solvent levels in the compartments 110, 112 drops below a threshold level (e.g. when completely empty). Each of the solvent and ink supply lines 114, 116 may comprise a probe (e.g. a male connector) which is configured to engage a corresponding port (e.g. female connector) in fluid communication with a respective solvent and ink compartment 110, 112. Before being introduced to the ink system, the ports on the cartridge 108 may be sealed. Upon introduction, or insertion, to the ink system, the seals may be pierced by the corresponding probes, thus placing the compartments 110, 112 in fluid communication with the solvent and ink supply lines 114, 116 respectively. It will be appreciated that a number of alternative options for placing the compartments 110, 112 in fluid communication with the solvent and ink supply lines 114, 116 exist (e.g. on-off valves etc.).

A solvent filter 122 interposes the cartridge 108 and the solvent refill pump 118 along the solvent supply line 114. Similarly, an ink filter 124 interposes the cartridge 108 and the ink refill pump 120 along the ink supply line 116. The purpose of the filters 122, 124 is to remove any small particulates from the solvent and ink before they pass downstream of the solvent and ink refill pumps 118, 120. Examples of such particulates include debris (e.g. rubber debris) from seals (e.g. needle septum seals) resulting from the introduction/insertion of the cartridge 108. The filters 122, 124 may be around 8 micron filters (e.g. mesh size).

A mixing valve 126 is provided between the solvent and ink supply lines 114, 116. The mixing valve 126 selectively places the solvent and ink supply lines 114, 116 in fluid communication with one another. This is primarily of use for directly providing solvent, from the solvent compartment 110, to a mixer tank 128 (which may be referred to as a mixing tank). When it is desired to add solvent from the solvent compartment 110 to the mixer tank 128 (e.g. ‘top up’ the mixer tank 128 with solvent), a flush valve 144 (disposed along flush line 170) is closed, mixing valve 126 is opened, and solvent refill pump 118 is activated. Closure of the flush valve 144 prevents solvent flowing past the flush valve 144. The ink refill pump 120 acts as a valve, when not pumping (e.g. as is the case when solvent is added to the mixer tank 128), and substantially prevents solvent travelling beyond the ink refill pump 120 towards the ink compartment 112 along ink supply line 116. Under action of the solvent refill pump 118, solvent is thus added to the mixer tank 128. For completeness, when it is desired to add ink from the ink compartment 112 to the mixer tank 128, mixing valve 126 is closed and ink refill pump 120 is activated. Under action of the ink refill pump 120, ink is thus added to the mixer tank 128 (along ink supply line 116).

It is in the mixer tank 128, which may be referred to as a storage tank or reservoir, that ink and solvent are mixed together. For example: when required, more solvent can be added to reduce the viscosity of the solvent-ink mixture in the mixer tank 128. From the fluid circuit 100 shown in FIG. 2 it will be appreciated that the solvent and ink refill pumps 118, 120 can be used to pump, or drive, solvent and ink respectively from the solvent and ink compartments 110, 112 of the cartridge 108 to the mixer tank 128.

Turning now to describe a main circuit of the fluid circuit 100, downstream of the mixer tank 128 an ink pump 130 is provided. The ink pump 130 is provided along a main supply line 132 which extends from the mixer tank 128 to a nozzle 134. The nozzle 134 may otherwise be described as an aperture of a droplet generator. The ink pump 130 is used to pump a mixture of ink and solvent from the mixer tank 128 to the nozzle 134. Downstream of the ink pump 130 is a filter module 136. The filter module 136 is replaceable when required. In the illustrated embodiment the filter module 136 has a filtration size of around 15 microns, but it will be appreciated that this may vary in other arrangements. The main supply line 132 is an example of one of a plurality of fluid conduits, which fluidly couples the print head to the ink system.

Downstream of the filter module 136, along the main supply line 132, a pressure transducer 138 and damper 140 are also provided. Continuing downstream, a feed valve 142 is provided. The feed valve 142 can selectively place the mixer tank 128 in fluid communication with the nozzle 134. The feed valve 142 is one valve of an array 141 of valves. Other valves in the array 141 include a flush valve 144, a purge valve 146 and a return valve 148. Each of these valves will be described in detail where appropriate.

Also forming part of the fluid circuit 100 is an array 150 of quick disconnect connectors. The array 150 of quick disconnect connectors are incorporated to provide for leak-free connection (and, more so, disconnection) of the print head (e.g. housing components in the third box 106) in operation. The array 150 of quick disconnect connectors comprises first to fourth connectors 152, 154, 156, 158. The array 150 of quick disconnect connectors may be omitted in some embodiments. Additional quick disconnect connectors may be provided in other embodiments. Less quick disconnect connectors may be provided in other embodiments.

Downstream of a first of the quick disconnect connectors 152 is a nozzle filter 160, which may be referred to as a last-chance filter. The nozzle filter 160 is provided just upstream of the nozzle 134. The nozzle filter 160 is incorporated to reduce the risk of any particulates blocking the nozzle 134. As ejected by the nozzle 134, a stream 162 of non-printing ink is shown entering a gutter 164. This is indicative of the ink which will not be applied to a substrate as part of a printing process, but will instead be recirculated back to the mixer tank 128. Whilst the above components form part of the print head, the print head also comprises a number of other components not shown in FIG. 2. For example, the print head comprises at least one electrode, e.g. a charge electrode 161 and a deflection plate 163 (also known as a deflection electrode). The deflection plate 163 may be held at a potential of around 8 kV from a reference electrode (e.g. ground plate). The deflection plate 163 and reference electrode may be referred to as a pair of deflection electrodes.

Continuing to describe the main circuit, the gutter 164 is connected to a main return line 166. The main return line 166 passes through a third 154 of the quick disconnect connectors to the return valve 148. Further downstream of the main return line 166 is a gutter pump 168. The gutter pump 168 applies constant suction in use to effectively pump a mixture of air, ink and solvent from the stream 162, via the gutter 164, back into the mixer tank 128. As will be appreciated from FIG. 2, the gutter pump 168 is disposed outside of the print head (e.g. outside of box 106). The operation of the main circuit thus concludes at this stage. The main return line 166, along with the ink main supply line 132, is an example of another of a plurality of fluid conduits which fluidly couple the print head to the ink system. The main return line 166 comprises: a first portion 166a and a second portion 166b. The first portion 166a extends from the gutter 164 to the gutter pump 168. The second portion extends from the gutter pump 168 to the mixer tank 128. The first portion 166a may be referred to as an upstream portion of the main return line 166, and the second portion 166b may be referred to as a downstream portion of the main return line 166.

The length of the first portion 166a of the main return line 166 may be at most 1 metre, which gives rise to advantages such as reduced pumping work and heat generation. In embodiments where the first portion 166a of the main return line 166 is at most 1 metre, the restriction between the gutter 164 and the gutter pump 168 is comparatively lower (e.g. than in known arrangements) and so less flow is needed to clear the gutter 164 and the first portion 166a of the main return line 166. Solvent use is reduced as a result. In some embodiments the length of the first portion 166a of the main return line 166 may be less than around 750 mm, may be less than around 500 mm. In some embodiments the length of the first portion 166a of the main return line 166 may be at least around 100 mm. The length of the first portion 166a may be preferably between around 100 mm and around 500 mm.

The functionality of the flush valve 144 will now be described. As will be appreciated from FIG. 2, when the mixing valve 126 is closed, such that the solvent and ink supply lines 114, 116 are not directly connected to one another, a flush line 170 provides a direct flow passage for solvent downstream of the solvent refill pump 118 to the flush valve 144 (and the nozzle 134). Flushing solvent through the nozzle 134 is particularly desirable during start-up and shut down procedures, to reduce the risk that the nozzle 134 becomes blocked. Whilst the nozzle flushing process occurs, the flush valve 146 is open and the gutter pump 168 applies suction, through a purge line 172, to draw the solvent from the nozzle 134 to the mixer tank 128. The purge line 172 is connected to the nozzle 134 via a side port 173. The gutter 164 can also be flushed with solvent in a similar manner. Whilst the gutter flushing process occurs, the mixing valve 126 is closed, the solvent refill pump 118 is activated, the flush valve 144 is open and the gutter pump 168 applies suction, through the main return line 166 (and open return valve 148), to draw the solvent from the gutter 164 to the mixer tank 128. The nozzle flushing process may utilise a higher flowrate of solvent owing to the solvent being drawn out of the side port 173 as opposed to the gutter 164 (the gutter 164 having a smaller cross-sectional area, and thus limiting the flowrate of fluid therethrough). The nozzle flushing process utilises a solvent jet, ejected from the nozzle 134, which is cleared by the gutter 164 and gutter pump 168. Advantageously, providing multiple fluid lines (e.g. the purge line 172 and the main return line 166) to the print head means that different cleaning processes can be carried out as needed. It will be appreciated that the gutter flushing process may, to at some extent, also clean the nozzle 134 given that the solvent passes through the nozzle 134.

A further line connected to the mixer tank 128 is vent line 174. The vent line 174 is connected to the mixer tank 128 via a vent filter 176. The vent line 174 passes through a fourth quick disconnect connector 158 of the array 150 of quick disconnect connectors. The vent line 174 opens out into the print head to provide a pressure release for the air drawn into the mixer tank 128 via the gutter pump 168. By venting out into the print head, the solvent losses from within the mixer tank 128 are comparatively lower than if the vent line 174 was to be vented to atmosphere. This is owing to the print head defining a generally enclosed volume, the air in which is saturated with solvent vapour.

The fluid circuit 100 provides a number of advantages over the fluid circuits known CIJ printers. Firstly, no ink heater is incorporated, which reduces the heat generated within the printer body. This is particularly advantageous given the relatively compact, low-volume nature of the printer according to embodiments of the invention (as will be described in detail below). The solvent and ink refill pumps 118, 120 are small, accurate diaphragm pumps which both pump, and measure, solvent and ink respectively. The pumps 118, 120 can therefore provide feedback (e.g. passive feedback) regarding the levels of solvent and ink use respectively. That is, the number of actuations of the pumps 118, 120 is indicative of the volume of fluid pumped across the pumps 118, 120. The presence of the ‘separate’ gutter pump 168, in combination with the ink pump 130, means that no venturi is needed to draw the ink/air/solvent mix back into the mixer tank 128 from the gutter 164 (as is typically the case in prior art fluid circuits). This results in a significant reduction of the heat generated within the printer body, at least because the ink pump 130 would otherwise have to pump up to around 100 times the volume of ink actually needed for printing in order to generate the necessary gutter suction by virtue of a venturi.

Although not shown in FIG. 2, various components of the fluid circuit 100, as well as other components of the printer more generally, are controlled by a controller (labelled 6 in FIG. 1). The controller receives signals from various sensors within the printer and is operable to provide appropriate control signals to components of the fluid circuit 100 (e.g. the solvent and ink refill pumps 118, 120, the ink pump 130, the gutter pump 168, the array 141 of valves) to control the flow of ink and solvent through the printer. The controller may be any suitable device known in the art, and typically includes at least a processor and memory.

Turning to FIG. 3, a perspective view of a printer 200 according to an embodiment of the invention is provided. The printer 200 comprises a printer body 202 and a print arm 204. The printer 200 shown in FIG. 3 generally corresponds to the schematic illustration of the printer 1 shown in FIG. 1.

The printer body 202 houses an ink system, components of which are generally bound by box 102 of FIG. 2. For example, the printer body 202 houses (with reference to FIG. 2) a cartridge 108, pumps (e.g. an ink pump 130), a mixer tank 128, and various fluid conduits extending therebetween (e.g. main supply line 132 and main return line 166). Although not shown in FIG. 3, the printer body 202 also houses a controller. The controller receives signals from various sensors within the printer 200 and is operable to provide appropriate control signals to components of the printer 200 to control the flow of ink and solvent through the printer 200.

The print arm 204 comprises a print head support arm 206 and a print head 208. The print head support arm 206 is pivotally connected to the printer body 202 about a rotatable coupling (not visible in FIG. 3). The print head support arm 206, and the print arm 204 more generally, are therefore rotatable about a print head rotation axis 210 with respect to the printer body 202. Arrow 212 indicates the directions of rotation in which the print arm 204 can rotate.

Advantageously, the print head 208 being pivotally connected to the printer body 202 means that the rotational position of the print head 208 can be adjusted, relative to the printer body 202, to a plurality of different rotational configurations. This provides greater flexibility of the position of the print head 208 relative to an external substrate, onto which printing occurs. The print head 208 is preferably rotatable through a range of around 270° about the print head rotation axis 210. The extent of print head 208 rotation may be limited to around 270° about the print head rotation axis 210 to avoid electrical/fluid conduits, which extend between the printer body 202 and the print head 208, getting damaged. However, in other embodiments the print head 208 may be rotatable about the print head rotation axis 210 by more than around 270°.

The print head rotation axis 210 is preferably horizontal during printing operations. A vertical position at which printing occurs on an external substrate can be adjusted by adjusting the rotational position of the print head 208. A horizontal position at which printing occurs is controllable by adjusting the print timing on an associated printing line.

The print head 208 is removable from the print head support arm 206. Specifically, the print head 208 may be described as being removably engageable with the print head support arm 206. The print head 208 may be removable by way of a snap-fit coupling or other detachable coupling. Specifically, as shown in FIG. 3, the print head 208 may be removable from a tiltable portion 214 of the print head support arm 206.

The tiltable portion 214 of the support arm is tiltable about a tilt axis 216. By virtue of the connection of the print head 208 to the tiltable portion 214, the print head 208 is also tiltable about the tilt axis 216. The tilt axis 216 may be described as a print head tilt axis. The tilt axis 216 is parallel to an ink ejection axis 218 defined by an ink ejection aperture (not shown in FIG. 3) of the print head 208. Arrow 220 indicates the relative direction of rotation (i.e. tilt) of the print head 208, and the tiltable portion 214 of the print head support arm 206, relative to a non-tilting portion 220 of the print head support arm 206. The print head 208 and tiltable portion 214 of the support arm 204 may be tiltable by up to around ±20° about the tilt axis 216 with respect to the non-tilting portion 220 of the print head support arm 206 (and so the printer body 202). The tilt axis 216 is preferably substantially orthogonal to the print head rotation axis 210. The print head rotation axis 210 is substantially orthogonal to the ink ejection axis 218.

Advantageously, being able to tilt the print head 208 relative to the printer body 202 can compensate for any slanting of the printed pattern that may otherwise result from the external substrate moving past the print head 208 at speed. The tiltable nature of the print head 208 thus facilitates printing onto high-speed print lines or onto sloping lines where printed characters may otherwise be distorted. However, in other embodiments the print head 208 may not tilt with respect to the printer body 202.

FIG. 3 also illustrates that the printer body 202 comprises a print head recess 222. The printer 200 can be placed in a stowed configuration in which the print arm 204 is rotated such that the print head 208, more generally the print arm 204, are received in the print head recess 222. Advantageously, this means that the overall footprint of the printer 200 is reduced when the printer 200 is in the stowed configuration. Furthermore, the print head 208 is better protected when the printer 200 is in the stowed configuration (desirable for, for example, when the printer 200 is in transit). For completeness, the printer 200 as shown in FIG. 3 is in a deployed (i.e. print-ready) configuration in which the print head 208 is not received within the print head recess 222. In the deployed configuration (of which there may be a number of different examples of deployed configuration), the print head 208 generally faces away from the printer body 202 such that the ink ejection axis 218 can be angled towards an external substrate on which printing is to be carried out.

Turning to FIG. 4, a perspective view of the printer 200 in an alternative configuration is provided. In FIG. 4 the printer 200 is shown in a stowed configuration in which the print head 208, and print arm 204 more generally, is received within the print head recess 222 of the printer body 202. The print arm 204, and so print head 208, are nested within the print head recess 222 of the printer body 202 in FIG. 4. The print head 208, and print arm 204, may therefore be described as nestable within the print head recess 222. The print arm 204 being nested within the print head recess 222 may otherwise be described as the print arm 204 being entirely contained within a major footprint defined by the printer body 202 (i.e. a volume defined by the printer body 202 in the absence of the print head recess 222).

In the stowed configuration (i.e. as shown in FIG. 4), the printer 200 may be substantially box-shaped or cuboidal. Approximate dimensions of the printer 200 in the stowed configuration, and so of the box-shape, may be in the region of 0.35 m×0.2 m×0.085 m. The volume of the printer 200 may be less than approximately 0.01 m2, more preferably less than around 0.006 m2. The printer 200 is thus significantly more compact than existing CIJ printers.

In the stowed configuration shown in FIG. 4, the print head 208 may be substantially sealed to facilitate cleaning or other maintenance. An outer, end face of the print head 208 may contact (e.g. interfere with) a sealing surface 223 of the recess 222 to provide the seal in some embodiments. Being able to clean/maintain the print head 208, and printer 200 more generally, with the print head 208 in the stowed configuration is desirable for at least the reason that initial splatter out of the print head 208 (e.g. due to pressure differences within the ink system) can be avoided on start-up. That is to say, undesirable ink/solvent ejection from the print head 208, which otherwise risks contamination of the associated printing line, can be avoided. It will also be appreciated that the printer 200 can be powered on, and any pre-printing cycles (e.g. a cleaning cycle) run, with the print head 208 in the stowed configuration. Returning briefly to FIG. 2, incorporation of the vent line 174, through which solvent-laden air can be draw into the print head 208 from the mixer tank 128, facilitates the ‘sealed’ start-up of the printer 200. This is owing to the mixer tank 128, return line 166, vent line 174 and print head forming a closed loop of sorts, allowing for pressure balancing within the system without using ‘fresh’ external air (which, owing to not being laden with solvent, would otherwise lead to increased solvent usage).

FIG. 5 is a perspective view of a print arm 1204 of a continuous inkjet printer in accordance with an embodiment of the invention.

The print arm 1204 comprises a printhead support arm 1206, a removable printhead 1208, and a removable cover 1301. The printhead 1208 and the printhead cover 1301 may be collectively referred to as a magazine, and the printhead cover 1301 may be interchangeably referred to as a magazine cover.

As will be clearer when describing FIG. 6 below, the printhead 1208 is removable from the printhead support arm 1206. That is to say the printhead 1208 can be disconnected from the printhead support arm 1206, such that a different printhead can be connected (or the same printhead 1208 reconnected) to the printhead support arm 1206. Although in this embodiment, and subsequent embodiments described below, the printhead 1208 is shown as being connected to a printhead support arm 1206, the printhead support arm 1206 may be replaced, for example, by an umbilical, such that the printhead 1208 is connectable to an umbilical, or the printhead 1208 by be directly connectable and removable from a printer housing.

The printhead support arm 1206 comprises a rotatable coupling 1303 for coupling to a rotation mechanism of a printer. The rotatable coupling allows for rotation of the print arm 1204. The printhead support arm 1206 further comprises a product detection sensor 1305. The product detection sensor is configured to sense the position of an external substrate that moves past the print arm 1204 to be printed on. The product detection sensor 1305 is provided in an end portion of the printhead support arm 1206 distal from the rotatable coupling 1303. Further details of the product detection sensor are described in relation to FIG. 6 and FIG. 8.

The removable printhead cover 1301 comprises three side walls 1307 (although only two are visible in FIG. 5) and an end face 1309, an elongate aperture 1311 is provided in the end face 1309. The removable printhead cover 1301 protects components of the printhead 1208 from external factors and environmental conditions such as moisture, dust, foreign particulates and extreme temperatures. The removable cover 1301 also provides the advantage of protecting an operator or a user from contacting high voltage (i.e. a voltage that could cause serious injury or death to a person) components of the printhead. The elongate aperture 1311 provides an opening for charged ink drops to exit the printhead 1208 and be printed onto an external substrate. In other embodiments the cover 1301 may not be removable, instead the cover 1301 may be permanently secured (for example, welded or glued) to the printhead 1208. Permanently securing the cover 1301 has the advantage that a user cannot contact components of the printhead 1208, in particular high voltage components which could cause death or serious injury to a person.

Turning to FIG. 6. FIG. 6 is an exploded view of the print arm 1204 shown in FIG. 5.

The print arm 1204 comprises the print head support arm 1206, the removable printhead 1208, and the removable cover 1301.

As described in relation to FIG. 5, the printhead support arm 1206 comprises a rotatable coupling 1303, which may also be referred to as a rotatable joint for coupling to a rotation mechanism of a printer. The rotatable coupling 1303 allows for rotation of the print arm 1204 about a rotation axis 1210.

The printhead support arm 1206 further comprises a tiltable portion 1313, which allows the printhead support arm 1208 to tilt about a tilt axis 1211.

The print arm 1204 comprises a printhead support arm connection interface 1315. The printhead support arm connection interface 1315 comprises a plurality of connectors for connection with corresponding connectors of the printhead 1208 (largely not visible in FIG. 6, but shown in FIG. 7). Said plurality of connectors may include the quick disconnect connectors of the circuit shown in FIG. 2. The printhead support connection arm interface 1315 comprises a gutter line connector 1317, a vent line connector 1319, a drive line connector 1321, a return line connector 1323, a mechanical latching barb 1325, a solenoid 1326, an extra high tension (EHT) connector 1327, and low voltage interface 1329.

The connectors of the printhead support arm connection interface 1315, in addition to being configured to connect to corresponding connectors of the printhead 1208, are, in use, connected to a continuous inkjet printer, including to an ink system.

The gutter line connector 1317 and the vent line connector 1319 are provided vertically above the other connectors of the printhead support connection interface 1315, in the orientation shown in FIG. 6. The term vertically above is not limited to being directly vertically above, but instead meaning that the gutter line connector 1317 and the vent line connector 1319 are above the other connectors, but that they do not necessarily lie in the same plane. The gutter line connector 1317 is a fluid connector and provides for connection between a gutter in the printhead 1208 and a mixing tank in an ink system. In use, based upon the schematic shown in FIG. 2, the gutter line connector 1317 would be in fluid communication with the return line 166. The return line 166 may also be referred to as a gutter line. The return line 166 allows for ink to be cleared from the printhead, and also draws in air so as to return air and ink back to the ink system. The vent line connector 1319 is also a fluid connector. The vent line connector 1319 provides for connection a vent line to open out into the printhead 1208 to provide a pressure release for air drawn into a mixing tank in an ink system of a printer, in particular when ink and/or solvent in cleared from the gutter of the printhead. By venting out into the printhead 1208, solvent losses from within the mixing tank are comparatively lower than if the vent line was to be vented directly to atmosphere in the printer body of the ink system. This is owing to the printhead 1208 defining a generally enclosed volume, the air in which is saturated with solvent vapour (or at least has an elevated solvent vapour concentration, relative to ambient air). A majority of the vented air, which can be saturated with solvent vapour, will be drawn back into the gutter, and recirculated, reducing the amount of fresh (i.e. not saturated with solvent vapour) air drawn into the system, and therefore also reducing the amount of solvent vapour vented.

The vent line connector 1319 may further be used when the print arm 1204 is in a stowed configuration (see FIG. 5). This is because when in the stowed configuration (i.e. in a post-printing or pre-printing operation), the vent line can provide a source of air to the gutter and gutter line 166. For example, if a print aperture of the printhead is sealed, the gutter draws in air that is saturated with solvent vapour which in turn reduces solvent consumption.

The drive (feed) line connector 1321 and the return line connector 1323 are both fluid connectors. The drive (feed) line connector 1321 and the return line connector 1323 are provided vertically below the gutter line connector 1317 and the vent line connector 1319, in the orientation shown in FIG. 6. Both the drive (feed) line connector 1321 and the return line connector 1323 may be self-sealing connectors. The return line connector 1323 may also be referred to as a main return line connector 1323. Whereby the return line connector 1323 provides for connection between the main return line 166 and the return valve of the main circuit shown in FIG. 2. The drive line connector 1321 and the return line connector 1323 are non-drip connectors, that is to say they comprise self-sealing valves and provide leak free connection (and, more so, disconnection). Although in other embodiments, the connectors 1321 and 1323 may not be self-sealing (non-drip).

The EHT connector 1327 and the low voltage interface 1329 are provided at a lower most region of the printhead support connection interface 1315. In other embodiments, the electrical connectors 1327, 1329 may be provided above the fluid connectors. Providing electrical connectors above fluid connectors may mitigate against fluid, particularly ink and/or solvent from running onto and damaging the electrical connectors, if the printhead 1208 and printhead support arm 1206 is connected and disconnected in a pre-determined orientation. The EHT connector 1315 allows for a high voltage connection to the printhead 1208. In particular, for applying a high voltage to a droplet generator in the printhead 1208, for generating a stream of charged ink droplets and/or to an electrode plate for deflecting the charged ink droplets. The low voltage interface 1329 is a low voltage connector in the form of a printed circuit board (PCB) comprising a plurality of individually mounted SMT (surface mounted technology) contacts, although other suitable low voltage connectors may be used. The EHT connector 1327 and the low voltage interface 1329 may be configured as an early break connection so that other signals can be powered down in preparation for removal of the printhead 1208. That is to say, that the EHT connector 1327 is arranged so that it is disconnected first. Disconnecting the EHT connector 1327 may then cause other electrical lines and connections to be turned off.

The printhead 1208 may comprise a resistor that is located close to the electrode plate (which may also be referred to as a deflection electrode). Components of the printhead 1208 including the electrode plate are shown and described in relation to FIG. 8. Providing the resistor in series with and close to the electrode plate may improve the safety of the printhead and mitigate against the need to provide additional internal housings around the electrode plate. When the printhead 1208 is disconnected from the printhead support arm 1206, the electrode plate may still be charged. Providing a resistor close to the electrode charge plate reduces the total capacitance of the resistor, electrode plate, and corresponding wiring (because of the shorter wires) which hence reduces the total amount of energy stored. When the printhead is in operation, and when disconnecting the printhead, solvent ingress may be present, and can readily ignite. Therefore, by limiting the energy stored, the likelihood of solvent igniting is reduced. In some embodiments, a resistor may be provided in the printhead 1208 and in the printhead support arm 1206, and each resistor being provided as close as possible to the connection interfaces of the printhead 1208 and the printhead support arm 1206 so as to limit the energy stored in each component.

The EHT connector 1327 may be configured such that a user cannot touch either the EHT connector 1327 of the printhead support arm 1206, or the corresponding EHT connector of the printhead 1208 (described below), when the printhead 1208 is removed. A gasket 1331 surrounds the EHT connector 1327, the low voltage interface 1329, and the solenoid 1326. In use, the gasket 1331 seals against a wall of the printhead 1208, in particular a wall of a printhead connection interface (described below). Because the gasket 1331 seals against a wall of the printhead 1208, any fluid that may leak or drip from the fluid connectors 1317, 1319, 1321, 1323 is prevented from contacting the electrical connectors 1327, 1329. If any ink or solvent contacts the electrical connectors 1327, 1329, the electrical connectors 1327, 1329 may be damaged and require replacement. This is advantageous because the EHT connector 1327 and the low voltage interface 1329, and possibly the solenoid, could be adversely affected by water, dust, or ink ingress. As described above, the fluid connectors are non-drip connectors. Therefore, when the printhead 1208 is removed from the printhead support arm 1206, the fluid in conduits connected to the fluid connectors 1317, 1319, 1321, 1323 does not drip onto the electrical connectors 1327, 1329, thereby mitigating against damage to the electrical connectors caused by fluid, in particular liquid.

The gasket 1331 may be formed form a synthetic elastomer, in particular from ethylene propylene diene monomer (EPDM) rubber. The EPDM rubber may be Parker grade E515 or 3540. Because the gasket 1331 may come into contact with ink and/or solvent, forming the gasket from a material such as EPDM rubber which is resistant to corrosion from ink and solvent, increases the lifetime of the gasket 1331 and hence the lifetime of other components, such as the electrical connectors of the printhead 1208 and the printhead support arm 1206.

As noted above, the printhead support arm connection interface 1315 comprises a mechanical latching barb 1323, the mechanical latching barb 1323 is for engagement with a self-coupling mechanical interlock, in particular a latch in the printhead 1208 for mechanically connecting the printhead 1208 to the printhead support arm 1206. The solenoid 1326 is use to electrically lock the mechanical latching barb 1325 with the latch of the printhead 1208. The use of the latching barb 1323, solenoid 1326 and latch of the printhead 1208 is described in more detail in below when describing FIGS. 9 and 10. Although the mechanical latching barb 1323 and corresponding latch of the printhead 1208 have a number of advantages described below, they are not essential to the removable printhead 1208. It will be appreciated that the connectors of the printhead support interface 1315 may be connected to corresponding connectors of the printhead 1208 without requiring a mechanical fastening.

In other embodiments, the latch of the printhead 1208 may be a solenoid. When the latch of the printhead is a solenoid, the solenoid 1326 does not need to be provided. In embodiments where the latch is a solenoid, the latch may be electrically locked so as to prevented disengagement between the latching barb 1325 and the latch.

The printhead support arm 1206 further comprises an elongate strut 1333. The elongate strut 1333 extends in a direction away from electrical connectors 1327, 1329 and the fluid connectors 1317, 1319, 1321, 1323 of the printhead support arm 1206. The elongate strut 1333 is generally orthogonal to a mating surface 1318 of the printhead connection interface 1339 which the electrical connectors 1327, 1329 and the fluid connectors 1317, 1319, 1321, 1323 are provided on. The printhead connection interface 1339 comprises an interface between the printhead and a body of the printer, which may include but is not limited to a printer body, a printhead support arm, and an umbilical. The printhead connection interface may comprise all features that connect to or with the body of the printer, or it may comprise only some of the features. The printhead connection interface 1339 may be interchangeably referred to as the connection interface 1339.

The printhead 1208 has a generally cuboidal shape, as such the elongate strut 1333 has an upper surface that is generally rectangular in shape so as to support the printhead 1208. The elongate strut 1333 comprises two guide rails 1335 which extend parallel to each other. The guide rails 1335 function as alignment means. The printhead 1208 comprises two cooperating guide runners 1337 (only one is visible in FIG. 6). The guide runners 1337 of the printhead 1208 in combination with the removable cover 1301 define two cooperating guide slots 1338 (shown more clearly in FIG. 7). The guide rails 1335 are received in the guide slots 1338 to providing a sliding relationship between the printhead 1208 and the printhead support arm 1206. That is to say, in order for the printhead 1208 to connect with the printhead support arm 1206, the guide rails 1335 of the printhead support arm 1206 must be received in the guide slots 1338 of the printhead 1208, a user can then slide the printhead 1208 towards the printhead support arm connection interface 1315. The presence of guide rails 1335 and corresponding guide slots 1338 provides for easy connection and disconnection, and alignment, of the printhead 1208 and printhead support arm connection interface 1315.

The guide rails 1335 extend along the elongate strut 1333 in a direction parallel with the tilt axis 1211. That is to say, the guide rails extend in the x-direction using the axes shown in FIG. 6. In other words, the guide rails 1335 extend in the long direction of the printhead, in a direction which is generally parallel to the tilt axis 1211. The guide rails 1355 extend from a distal end of the elongate strut 1333 to where the electrical connectors 1327, 1329 and the fluid connectors 1317, 1319, 1321, 1323 are provided, such that the guide rails 1335 meet the mating surface 1318. Because the guide rails 1335 are long, and meet the electrical connectors 1327, 1329 and the fluid connectors 1317, 1319, 1321, 1323, they provide secure guidance of the printhead before the corresponding connectors of the printhead 1208 engage with the electrical connectors 1327, 1329 and the fluid connectors 1317, 1319, 1321, 1323 of the printhead support arm 1206. In other embodiments the guide rails 1335 may extend close to the electrical connectors 1327, 1329 and the fluid connectors 1317, 1319, 1321, 1323 but not meet the electrical connectors 1327, 1329 and the fluid connectors 1317, 1319, 1321, 1323.

The guide rails 1335 thus permit linear movement of the printhead in the x-direction but restrict movement of the printhead 1208 in the y-direction. Furthermore, the guide rails 1335 are L-shaped rails. The advantage of having L shaped rails is that movement of the printhead 1208 in the z direction is restricted. Thereby, further ensuring correct alignment of the electrical connectors 1327, 1329 and the fluid connectors 1317, 1319, 1321, 1323 with the corresponding connectors of the printhead 1208.

Turning to the printhead 1208. The printhead 1208 comprises a connection interface 1339 (not visible in FIG. 6, but shown in FIG. 7), a shroud 1341, and a print deck 1343. In some embodiments, the printhead 1208 and/or the printhead support arm 1206 may comprise a printhead controller, for example a touch screen. The printhead controller may be arranged to control actuation of the solenoid and/or control power supply to components of the printhead 1208. The print deck 1343 comprises a droplet generator (which may be referred to as a nozzle) for generating and ejecting a stream of ink droplets for printing; at least one electrode for steering the stream of ink droplets; and a gutter for receiving droplets of ink which are not used for printing. The droplet generator (ink jet nozzle) may be a 60 micron droplet generator. The droplet generator (ink jet nozzle) may be a 70 micron droplet generator. In some embodiments, the ink jet nozzle may be 42 microns. In some embodiments, the ink jet nozzle may be 50 microns. In some embodiments, the ink jet nozzle may be 65 microns. In some embodiments, the ink jet nozzle may be 75 microns. In some embodiments, the ink jet nozzle may be between around 30 microns to around 80 microns. In some embodiments, the ink jet nozzle may be between around 30 microns to around 90 microns. The above dimensions of the droplet generators (ink jet nozzles) relate to the diameter of the orifice. The droplet of ink generated may have a diameter that is approximately twice the diameter of the orifice.

The components of the printhead 1208 are described in more detail in relation to FIG. 8.

In some embodiments the droplet generator and the gutter of the printhead 1208 may be replaceable. This facilitates quick resolution of nozzle blockage issues that cannot resolved by normal cleaning.

The removable cover 1301 is configured to be received over the printhead 1208 so as to cover the print deck 1343. The removable cover 1301 may comprise clips which cooperate with grooves in the printhead 1208 in a ‘pinch and withdraw’ type mechanism. The clips may each have a protrusion that cooperates with, and/or abuts, a step, or stepped portion, within their respective groove such that when the clips are fully inserted into the grooves, the clips cannot be pulled out of the grooves with a purely linear motion. The user may need to bias (e.g. ‘pinch’) the clips so that the protrusion can overcome the stepped portion and can then be pulled out of the groove with a purely linear motion.

The printhead 1208, in particular the shroud 1341 and/or the removable cover 1206 may be formed from polypropylene, as this material is resistant to corrosion from ink and solvents that the printhead may come into contact with.

In some embodiments the removable cover 1301 may only be removed once the printhead 1208 is disconnected from the printhead support arm connection interface 1315 and/or completely removed from the printhead support arm 1206 (i.e. where the guide rails 1335 of the printhead support arm 1206 are not in engagement with corresponding guide slots 1338 of the printhead 1208). In particular, the printhead 1208 may only be disconnected from the printhead support arm 1206 by simultaneously removing the printhead 1208 and the removable cover 1301, and then removing the removable cover 1301 from the printhead 1208 once disconnection has taken place. This is advantageous, because it prevents a user from contacting components of the printhead during use, and allows the user to remove the printhead 1028 and removable cover 1301 in a single step.

In other embodiments, it may be possible to remove the removable cover 1301 without disconnecting the printhead 1208 from the print arm 1206. In such embodiments, the printhead may comprise additional internal housings/casings so as to mitigate against a user contacting components of the printhead 1208.

It can be seen more clearly in FIG. 6 that the end face 1309 of the removable cover does not cover the lowermost end portion of the printhead support arm 1206, where the production detection sensor 1305 is provided. In embodiments, where the product detection sensor 1305 is not provided in the printhead support arm 1305, the removable cover may cover the lower most end portion of the printhead support arm 1206.

FIG. 7 shows a perspective end view of the printhead 1208, in particular showing the connection interface 1339 of the printhead 1208 which is not visible in FIG. 5 or 6.

The connection interface 1339 comprises a plurality of fluid connectors and a plurality of electrical connectors for connection with corresponding connectors of the printhead support arm connection interface 1315. In particular, the connection interface 1339 of the printhead 1208 comprises a gutter line connector 1345 for connection with the gutter line connector 1317 of the printhead support arm connection interface 1315.

The connection interface 1339 further comprises a vent line connector 1347, for connection with the vent line connector 1319 of the printhead support arm connection interface 1315. The connection interface 1339 further comprises a drive line connector 1349 and a return line connection 1351, for connecting to the drive line connector 1321 and the return line connector 1323 of the printhead support arm connection interface 1315 respectively.

The fluid connectors 1345, 1347, 1349, 1351 are quick disconnect connectors. Quick disconnect connectors allow for fast disconnection between corresponding connectors. By way of example, in the present embodiment the fluid connectors 1345, 1347, 1349, 1351 can be quickly disconnected from the corresponding connectors of the printhead support arm interface 1315 by a user simply pulling and sliding the printhead 1208 in a direction away from the printhead support arm 1206 and parallel to the elongate strut 1333, without have to perform any other manual operation (such as rotation of part of a connector) in order to disconnect the connectors.

The connection interface 1339 of the printhead 1208 further comprises an Extra High Tension (EHT) connector 1353 and a low voltage interface 1355, for connecting with the EHT connector 1327 and the low voltage interface 1329 of the printhead support arm connection interface 1315. The EHT connector 1353 and the low voltage interface 1355 are both quick disconnect connectors. Quick disconnect connectors allow for fast disconnection between corresponding connectors. By way of example, in the present embodiment the EHT connector 1353 and the low voltage interface 1355 can be quickly disconnected from the corresponding connectors of the printhead support arm interface 1315 by a user simply pulling and sliding the printhead 1208 in a direction away from the printhead support arm 1206 and parallel to the elongate strut 1333, without have to perform any other manual operation (such as rotation of part of a connector) in order to disconnect the connectors.

The connection interface 1339 of the printhead 1208 further comprises a first aperture 1357 for receiving the mechanical latching barb 1326 and of the printhead support arm connection interface 1315, and a second aperture 1359 for receiving the solenoid of the printhead support arm connection interface 1315. The first aperture 1357 and the second aperture 1359 at least partly define a self-coupling mechanical interlock, for mechanically connecting the printhead 1208 to the printhead support arm 1206.

As can be seen in FIGS. 6 and 7, all of the connectors save as for the EHT connector 1353, are of the printhead 1208 are female connectors, and the corresponding connectors on the printhead support arm 1206 are male connectors. It will be appreciated that in other embodiments different combinations of male and female connectors can be provided.

The printhead connection interface 1339 comprises an end face 1361 from which the fluid and electrical connectors (1345, 1347, 1349, 1351, 1353, 1355) and apertures 1357, 1359 extend and is configured to mate with the mating surface 1318 of the printhead support arm 1206. However, the end face 1361 is not a flat surface and comprises a stepped region 1363, such that a lower region 1361a of the face 1361 in the orientation shown in FIG. 7 is offset from an upper region 1361b of the face 1361. The fluid connectors 1345, 1347, 1349, 1351 all extend from the upper region 1361b, and the electrical connectors 1353, 1355 extend from the lower region 1361a. As such the upper region 1361b overhangs the lower region 1361a, this is advantageous as it mitigates against fluid (in particular ink and/or solvent) from contacting the electrical connectors 1353, 1355 thereby preventing damage to the electrical connectors 1353, 1355.

It will be appreciated that in other embodiments, the connectors shown on the connection interface 1339 of the printhead 1208 may be provided on the printhead support arm connection interface 1315. Likewise, the connectors shown on the printhead support arm connection interface 1339 may be provided on the connection interface 1339 of the printhead 1208, and or any other combination, so long as there are corresponding connections on the connection interface 1339 of the printhead 1208 and the printhead support arm connection interface 1315.

Further, although the printhead 1208 is described and shown as being connected to a printhead support arm connection interface 1315, it will be appreciated that in other embodiments, the printhead 1208 may be connected directly to an umbilical or to a printer.

FIG. 8 is a side view of the print arm 1204 shown in FIGS. 5 and 6, with a partial cut-through to show internal components of the printhead 1208 and the printhead support arm 1206.

As briefly described in relation to FIG. 6, the printhead support arm 1206 comprises a product detection sensor 1305. The product detection sensor 1305 is configured to sense the position of an external substrate that moves past the print arm 1204 to be printed on.

The product detection sensor 1305 is provided in an end portion of the printhead support arm 1206 distal from the rotatable coupling 1303, in particular it is provided in a housing of the elongate strut 1333. The product detection sensor 1305 is integrated into the printhead support arm 1206 In other embodiments the product detection sensor 1305 may be provided in the printhead 1208. The production detection sensor 1305 comprises a sensor 1365 which is configured to generate a sensor beam 1367 (shown as a dashed line), and a lens 1369 for focusing the sensor beam 1367. In other embodiments the product detection sensor may comprise a plurality of sensor beams and/or a plurality of lenses. In embodiments where the product detection sensor 1305 comprises two sensors 1365, a sensor 1365 may be provided at either side of the location where ink droplets are ejected from the printhead 1208 (i.e. at either side of the elongate aperture 1311 of the removable cover 1301). The product detection sensor 1305 is arranged to detect the product/substrate to which ink droplets are to be printed onto and in some embodiments is able to sense the direction and speed of the product. The product detection sensor 1305 may be a standard sensor. For example, the product detection sensor 1305 may comprise a VL6180X proximity detector (produced by STMicroelectronics) or the product detection sensor 1305 may comprise a photoelectric sensor (also known as a photocell pair sensor), which may use infrared radiation. The product detection sensor 1305 being located in the printhead support member 1206 allows for a more compact printhead 1208. In addition, the cost of producing a removable printhead 1208 may be reduced as the printhead 1208 does not need to comprise a product detection sensor 1305.

The product detection sensor 1305 is set back from the elongate aperture 1311 of the removable cover 1301 where ink droplets are ejected from the printhead 1208. This mitigates against ink droplets splattering on the product detection sensor 1305.

Preferably, the detection area, i.e. the area that the product detection sensor 1305 covers, should be less than 5 mm below the gutter. This is so that the product detection sensor 1305 can sense in the area where printing is required.

The printhead 1208 further comprises a droplet generator 1501 having a nozzle 1503 and a gutter 1505. During printing operations, a jet of ink is ejected from the nozzle 1503 of the droplet generator 1501 towards the gutter 1505 along a printing axis A. The droplet generator 1501 further comprises a piezoelectric element (not shown in FIG. 8) which allows the inkjet to be modulated, causing droplets to form within the jet in a predictable way.

A charge electrode 1507 is provided adjacent to the droplet generator 1501 and, as is well known in the art, configured to cause a charge to be induced on droplets as they break off from the ink jet emitted from the droplet generator 1501. A voltage of around 300V may be applied to the charge electrode 1507. First and second deflection electrodes 1509 and 1511 are arranged either side of the printing axis A and are configured to cause the charged droplets to deflect from the printing axis A and therefore miss the entrance of the gutter 1505. A voltage of around 6000-8000 volts may be applied between the first and second deflection electrodes 1509, 1511 in order to cause the droplets to deflect.

By varying the magnitude of the charge voltage applied to the charge electrode 1507, the amount of charge induced on each of the droplets can be varied, and in this way the amount of deflection in the static electric field established between the deflection electrodes 1509, 1511 can be varied for each droplet.

The droplet generator 1501, gutter 1505, charge electrode 1507 and deflection electrodes 1509, 1511 are all mounted within the printhead, meaning that there is a fixed positional relationship between each of these components.

FIG. 9 is a perspective cut through view of the printhead 1208 and printhead support arm 1206 comprising a self-coupling mechanical interlock 1371 in an unlatched (i.e. de-coupled) state; and FIG. 10 shows the self-coupling mechanical interlock in a latched (i.e. coupled) state. The self-coupling mechanical interlock can be considered to form part of the printhead connection interface 1339.

The self-coupling mechanical interlock 1371 may be interchangeably referred to as a self-locking mechanical coupling assembly 1371 or as a mechanical interlock. The printhead 1208 comprises a biased latch 1373. The latch 1373, comprises an arm 1375 that extends in a direction generally orthogonal to direction which the mechanical latching barb 1325 extends. The arm 1375 of the latch 1373 comprises an aperture 1381 which is sized to receive the mechanical latching barb 1325.

The latch 1373 comprises a push button 1377 which is flush with a side wall 1307 of the removable cover 1206 when in a latched state (FIG. 10). The push button 1377 being flush with the side wall 1307 mitigates against a user accidently depressing the push button 1377 or the button becoming caught or contacted on an external object which could cause unwanted release of the printer. The latch 1373 comprises a biasing spring (not shown) which is arranged to urge the push button 1377 and hence the arm 1375, which the push button 1377 is connected to, towards the side wall 1307. In other words, the biasing spring urges the latch 1373 in the direction of the arrow 1379 shown in FIG. 10. That is to say, the biasing spring prevents the push button 1377 from being pressed unless the solenoid 1326 is in a retracted position.

As can be seen more clearly in FIG. 6, the mechanical latching barb 1325 comprises a locking region 1325a, and a distal end having a frustocronical head 1325b. The locking region 1325a having a diameter that is smaller than the diameter of the base of the frustoconical head 1325b. In other words, the diameter of the locking region 1325a of the latching barb 1325 is smaller than the diameter of the distal end of the latching barb 1325 immediately adjacent the locking region 1325a.

Returning back to FIGS. 9 and 10. When in the latched state (FIG. 10), the connectors (i.e. fluid and electrical connectors) of the printhead 1208 are connected to the corresponding connectors of the printhead support arm 1208. Such that the gasket 1331 of the printhead support arm 1206 abuts a surface of the printhead 1208. In particular, the gasket 1331 abuts the surface 1361a of the printhead 1208. The mechanical latching barb 1325 is received in the aperture 1381 of the arm 1373. The aperture 1381 is a circular aperture, because the mechanical latching barb 1325 has a circular cross section. In other embodiments, the mechanical latching barb 1325 may have any suitable cross sectional shape such as a square cross section, other suitable shapes of the mechanical latching barb cross section, and aperture 1381 may be used.

The aperture of the 1381 is sized such that when the centre of the aperture (i.e. the centroid of the aperture) is aligned with the central axis 1383 of the latching barb 1325 (shown on FIGS. 6 and 10), the latching barb 1325 is free to extend through the aperture 1381, and the aperture 1381 may freely slide over the mechanical latching barb 1325. The latching barb 1325 has a length such that when the electrical and fluid connectors of the printhead 1208 are connected to the corresponding connectors of the printhead support arm 1206, the locking region 1325a of the latching barb is aligned with the arm 1377 of the latch 1373, and extends through the aperture 1381. Thereby an internal wall of the latch 1373 which defines the aperture 1381 lies in the same plane and is able to contact the locking region 1325a.

In the present embodiment, in order for the axis 1383 of the latching barb 1325 to be aligned with the centroid of the aperture 1381, the latch 1373 must be actuated by a user away from the side wall 1307 of the removable cover 1206. A user is able to actuate the latch 1373 in this manner by depressing the push button 1377 to provide a force opposite to the biasing spring force. As shown in FIG. 9, a user can depress the push button 1377 so as to actuate the latch 1373, as indicated by arrow 1385, this causes the centroid of the aperture 1381 to be aligned with the axis 1383 of the latching barb 1325. The user may then slide the printhead 1208 away from the printhead support arm 1206 as indicated by arrow 1387. Therefore, quick disconnection of the printhead 1208 from the printhead support arm 1206 can be achieved. However, if the push button 1377 is not depressed, the user would be unable to remove the printhead 1208. This is because when in the latched state, as shown in FIG. 10, the centroid of the aperture 1381 is not aligned with the central axis 1383 of the mechanical latching barb. This misalignment results in the latching barb 1325 being unable to pass through the aperture 1381, thus in the latched stated the printhead 1208 and the printhead support arm 1206 are mechanically locked. This mechanical interlock is advantageous as it prevents the printhead 1208 from becoming disconnected from the printhead support arm 1206 during printing operations. This is particularly important when the printhead 1208 is used in a printer such that those shown in FIGS. 3 and 4, where the printhead 1208 can be manoeuvred (rotated, tilted and translated) during use into a number of positions. The mechanical interlock also prevents removal of the printhead 1028 while valves of the fluid connectors are open. Further, because the use of the latch 1377 mitigates against a user having to use any fasteners such as screws in order to achieve a secure mechanical coupling between the printhead 1208 and the printhead support arm 1206, the provision of the mechanical interlock does not substantially increase downtime of a printer when removing and replacing the printhead 1208.

For additional safety during printing, the mechanical interlock 1371 is electrically locked. This electrical locking is achieved by the solenoid 1326. The solenoid 1326 is controlled by a controller of the printer to be actuated into an extend position so as to engage the arm 1375 of the latch 1373.

When connecting the printhead 1208 to the printhead support arm 1206, the solenoid 1326 is in a retracted position, by the controller 6 (see FIG. 1) causing electric current to be applied to the solenoid 1326, such that the solenoid 1326 does not contact the arm 1375 of the latch 1373. Once the printhead 1208 is connected to the printhead support arm 1206 and the latch 1371 is in a latched state, as shown in FIG. 10, the electrical current may be removed from the solenoid 1326 causing movement of the solenoid 1326 to a normal (i.e. un-retracted position, or extended position). When the solenoid 1326 is in the normal position, it is received in a second aperture 1389 (or in some embodiments recess) of the arm 1375. The solenoid 1326 being received in a second aperture 1389 prevents lateral (in the y-direction) movement of the arm 1375, and thus prevents a user from being able to actuate the arm 1375 by depressing the push button 1385. Lateral movement of the arm 135 is indicated by the arrows 1385 in FIG. 9, and 1379 in FIG. 10. The solenoid 1326 is said to electrically lock to the mechanical interlock 1373 because the solenoid 1326 can only be retracted to allow movement of the arm 1375 when an electrical current is applied to the solenoid 1326 to cause the solenoid 1326 to move to a retracted position. Electrically locking the mechanical interlock 1373 further increases user safety. This is because the printhead 1208 cannot be removed until an electrical current is applied to the solenoid 1326. This further prevents a user from removing a printhead 1208 during printing operations, where high voltages may be present in the printhead.

A further advantage of the solenoid 1326 being arranged such that it moves to a retracted position when a current is applied, is that if there is any power failure, the solenoid will remain in the normal position (and prevent movement of the arm 1375). This is because no current and hence power is required in order to maintain the solenoid 1326 in the normal position to electrically lock to the latch 1373. In other words, the printhead 1208 is locked if there is no power supply. In some embodiments, the print arm may be configured such that the printhead 1208 can be removed in the event of power failure. Said configuration may be arranged such that a user can manually retract the solenoid.

It will be appreciated that in other embodiments, the solenoid 1326 may be arranged such that when no current is applied the solenoid 1326 is in a retracted position (i.e. is not engaged with the arm 1375), and when an electric current is applied, the solenoid 1326 is actuated so as to engage the arm 1327 and prevent movement of the arm.

In further detail, when connecting the printhead 1208 to the printhead support arm 1206, the solenoid 1326 is in a retracted position, since the controller is configured to cause no electric current to be applied to the solenoid 1326. That is, when in a non-excited or OFF state the solenoid 1326 is in a retracted position. This results in the solenoid 1326 not contacting the arm 1375 of the latch 1373.

Once the printhead 1208 is connected to the printhead support arm 1206 and the latch 1371 is in a latched state, as shown in FIG. 10, the electrical current may be applied to the solenoid 1326 such that the solenoid 1326 is in an excited or ON state, causing movement of the solenoid 1326 to a normal (i.e. un-retracted position, or extended position). When the solenoid 1326 is in the normal position, it is received in a second aperture 1389 (or in some embodiments recess) of the arm 1375. The solenoid 1326 being received in the second aperture 1389 prevents lateral movement of the arm 1375 (in the y-direction), and thus prevents a user from being able to actuate the arm 1375 by depressing the push button 1385. Lateral movement (in the y-direction) of the arm 1375 is indicated by the arrows 1385 in FIG. 9, and 1379 in FIG. 10. The solenoid 1326 is said to electrically lock to the mechanical interlock 1373 because the solenoid 1326 can only be retracted to allow movement of the arm 1375 when an electrical current is removed to cause the solenoid 1326 to move to a retracted position. Electrically locking the mechanical interlock 1373 further increases user safety. This is because the printhead 1208 cannot be removed until no electrical current is applied to the solenoid 1326. This further prevents a user from removing a printhead 1208 during printing operations, where high voltages may be present in the printhead.

Furthermore, it will be appreciated, the solenoid 1326 is not essential to the use of the mechanical interlock 1371, but that it provides additional safety to the printhead 1208. The solenoid 1326 may be omitted from other embodiments. In other embodiments, the printhead 1206 may comprise the solenoid 1326.

FIG. 11 shows a perspective end view of a model another printhead support arm 2206 for connection with a printhead (not shown).

For brevity, only the differences between the printhead support arm 1206 and the printhead support arm 2206 will be described.

As with the printhead support arm 1206, the printhead support arm 2206 comprises a plurality of electrical connectors and a plurality of fluid connectors. In particular, the plurality of fluid connectors and the plurality of electrical connectors are provided on a printhead support arm connection interface 2315. The printhead 2206 comprises a high voltage connector 2327 and a low voltage connector 2329. The high voltage connector 2327 and the low voltage connector 2329 may be the same type of connectors as described in relation to FIGS. 6 to 10.

The printhead support arm connection interface 2315 further comprises a gutter line connector 2317, a vent line connector 2319, a drive line connector 2321, and a return line connector 2323, which together define fluid connectors. The fluid connectors, 2317, 2319, 2321, and 2323 may be the same type of connectors as those described in relation to FIGS. 6 to 10.

The printhead support connection interface 2315 further comprises a mechanical latching barb 2325. The mechanical latching barb 2325 of FIG. 11 differs from the mechanical latching barb in FIGS. 6 to 10, in that it comprises a first region 2325a, which extends from a face 2328 of the printhead support arm connection interface 2315, having a first diameter. The latching barb 2325 comprises an end region 2325b distal from the face 2328 of the printhead support arm connection interface 2315. The end region 2325b has a frustroconcial shaped end, having a base diameter that is equal to the first diameter of the first region 2325a. The latching barb 2325 further comprising a locking region 2325c, the locking region 2325c being provided between the first region 2325a and the end region 2325c and having a diameter that is smaller than the first diameter. As with the latching barb 2325 in FIGS. 6 to 10, the locking region 2325c of the latching barb 2325 is configured to engaged with a latch of a printhead in the same manner as described in relation to FIGS. 6 to 10.

The printhead support arm connection interface 2315 also comprises a solenoid 2326. The solenoid 2326 functions in the same manner as the solenoid 1236.

The arrangement (layout) of the connectors of the printhead support arm connection interface 2315 differs from the arrangement of the printhead support arm connection interface 1315. In the orientation shown in FIG. 11, the high voltage connector 2327 and the low voltage connector 2329 are provided at a left-hand side of the interface 2315. Further, the high voltage connector 2327, the low voltage connector 2329 and the solenoid 2326 are provided on a protruding structure 2330 that extends from the face 2326. The gutter line connector 2317 and the vent line connector 2319 are provided below the protruding structure 2330. That is to say the protruding structure 2330 overhangs the gutter line connector 2317 and the vent line connector 2319. The advantage of this arrangement is that fluid which may drip from the gutter line connector 2317 and the vent line connector 2319 will not drip onto electrical connectors, when the printhead support arm 2206 and printhead 2208 (not shown) is in the orientation shown. The orientation shown in FIG. 11 may be the orientation that the printhead support arm 2206 is required to be in, in order to connect and disconnect a printhead. Further, the drive line connector 2321 and the return line connector 2323 are provided the to the right of the protruding structure 2330 (in the orientation shown in FIG. 11). Likewise, the drive line connector 2321 and the return line connector 2323 are positioned so as to mitigate against any fluid which may drip from these connectors from contacting the electrical connectors 2327, 2330.

The printhead support arm 2206 or a corresponding printhead may comprise an orientation sensor to determine to the orientation of the print head support arm 2206; or in some embodiments, a stepper motor may be used to cause rotation of the print arm and the number of steps taken by the stepper motor may be extrapolated to determine the orientation of the printhead support arm 2206. Disconnection of the printhead from the printhead support arm 2206 may be prohibited unless the printhead support arm 2206 is in a predetermined orientation, for example a horizontal orientation.

The printhead support arm 2206 comprises an elongate strut 2333. The elongate strut 2333 extends in a direction away from the printhead support arm connection interface 2315 and provides a support for the printhead (not shown). The printhead for connection with the printhead support arm 2206 may have a similar shape to the printhead 1208 in FIGS. 6 to 10, although it will be appreciated that the connectors on a printhead for connection with the printhead support arm 2206 will be arranged to be complementary to the connectors of the printhead support arm connection interface 2315.

The elongate strut 2333 comprises two guide rails 2335 which extend parallel to each other. The guide rails 2335 function as alignment means for a printhead which would comprise cooperating guide slots, of the type described in relation to FIGS. 6 to 10.

The guide rails 2335 differ from the guide rails 1335 of FIGS. 6 to 10, in that the guide rails 2335 are not parallel along their entire length. Instead the guide rails 2335 comprise a diverging tapered end 2335a. That is to say, the perpendicular distance represented by dashed arrow 2401 between the rails 2335 at the diverging tapered end 2335a is greater than the perpendicular distance between the rails 2335 where the rails 2335 are parallel (i.e. closer to the face 2328) represented by dashed arrow 2403.

The diverging tapered end region 2335a provides a first coarse guidance to aid in quick connection of a printhead to the printhead support arm 2206, and hence to an ink system. The tapered end region 2335a allows for a lower degree of precision by a user aligning the slots (guide features) of a corresponding printhead with the guide rails 2335. This is because a user may generally align the slots of the printhead with the corresponding rails 2335 of the printhead support arm 2206 and as the user slides the printhead and hence the plurality of fluid and electrical connectors towards the corresponding connectors of the printhead support arm connection interface 2315. The diverging tapered end 2335a allows the user to guide the printhead towards the face 2328, where the guide rails 2335 are parallel, and thereby ensuring that the connectors of the printhead connection interface align with the corresponding connectors of the printhead support arm connection interface 2315.

In addition to providing alignment of corresponding connectors between the printhead and printhead support arm 2206, the guide rails 2335 may also mitigate against damage to the connectors by ensuring that the printhead is always provided in the correct orientation. If the printhead was provided in an incorrect orientation, the guide rails 2335 would not be able to be received in corresponding slots of the printhead. This would thus force an offset to the be caused between the connectors of the printhead and corresponding connectors of the printhead support arm 2206, thus preventing a user from trying to force connection between slightly misaligned connectors or between non-corresponding connectors, which could damage the connectors. This is because the guide rails 2335 must first be received in the guide slots 2338 defined by a corresponding printhead and removable cover. The printhead can then be guided towards the electrical and fluid connectors of the printhead support arm 2206. As such the connection process of the printhead to the ink system (i.e. printhead support arm) can be considered to be a two-step process of:
1. receiving the guide rails 2335 in corresponding guide slots; and
2. connecting the corresponding fluid and electrical connectors of the printhead with the printhead support arm.

In some embodiments, the second step may include engagement of a self-coupling mechanical interlock.

It will be appreciated that the guide rails 2335 shown in FIG. 11 may be applied to the embodiment shown in FIGS. 6 to 11, and the guide rails 2335 may be replaced with other suitable alignment structures, for example guide pins. In addition, the guide rails may be provided on a printhead, and the elongate strut 2333 may instead comprise corresponding guide slots, where the guide slots comprise a diverging tapered end region.

For completeness, the features of the printhead support arm connection interface 2315 and elongate strut 2333 may form part of an umbilical or a printer for connecting a removable printhead. The elongate strut 2333 may also comprise a product detection sensor of the type shown in FIGS. 6 to 10.

FIG. 12 shows a perspective end view of a model of another printhead support arm 3206 and FIG. 13 shows an end view of the printhead support arm 3206.

For ease of understanding, only the differences between the printhead support arm 3206 and the printhead support arms 1206 and 2206 will be described.

As with the printhead support arms 1206 and 2206, the printhead support arm 3206 comprises a plurality of electrical connectors and a plurality of fluid connectors. In particular, the plurality of fluid connectors and the plurality of electrical connectors are provided on a printhead support arm connection interface 3315. The printhead 3208 comprises a high voltage connector 3327 and a low voltage connector 3329. The high voltage connector 3327 and the low voltage connector 3329 may be the same type of connectors as described in relation to FIGS. 6 to 10 and FIG. 11. However, it can be seen that in contrast the printhead support arm connection interface 1315, the high voltage connector 3327 is a male connector. Whereas in the printhead support arm connection interface 1315 of FIGS. 6 to 10 the EHT connector 1327 is a female connector, this arrangement may further reduce the likelihood of ink and/or solvent from fluid connectors from contacting the EHT connector.

The printhead support connection arm interface 3315 further comprises a gutter line connector 3317, a vent line connector 3319, a drive line connector 3321, and a return line connector 3323, which together define fluid connectors. The fluid connectors, 3317, 3319, 3321, and 3323 may be the same type of connectors as those described in relation to FIGS. 6 to 10 and FIG. 11.

The printhead support connection interface 3315 further comprises a mechanical latching barb 3325. The mechanical latching barb 3325 of FIG. 12 is of the same type shown in FIGS. 6 to 10.

The printhead support arm connection interface 3315 also comprises a solenoid 3326. The solenoid 3326 functions in the same manner as the solenoid 1236 in FIGS. 6 to 10, and FIG. 11.

The arrangement (layout) of the connectors of the printhead support arm connection interface 3315 differs from the arrangement of the printhead support arm connection interface 1315 and 2315 in FIGS. 6 to 10, and 11, respectively. In the orientation shown in FIGS. 12 and 13, the high voltage connector 3327 and the low voltage connector 3329 are provided on an upper region of the interface 3315. Further, the high voltage connector 3327, the low voltage connector 3329, the solenoid 3326, and the mechanical latching barb 3325 are provided on a protruding structure 3330 that overhangs a face 3328 of the printhead support arm 3206. The gutter line connector 3317, the vent line connector 3319, the drive line connector 3321, and the return line connector 3323 are provided below the protruding structure 3330. That is to say the protruding structure 3330 overhangs gutter line connector 3317, the vent line connector 3319, the drive line connector 3321, and the return line connector 3323. The advantage of this arrangement is that fluid which may drip from gutter line connector 3317, the vent line connector 3319, the drive line connector 3321, and the return line connector 3323 when the printhead support arm 3206 and printhead 3208 (not shown) is in the orientation shown. This is the orientation that may be required in order to connect and more so disconnect a printhead from the printhead support arm 3206. The gutter line connector 3317 and the vent line connector 3319 and disposed between the drive line connector 3321 and the return line connector 3323.

The printhead support arm 3206 also comprises an elongate strut 3333. The elongate strut 3333 extends in a direction away from the printhead support arm 3206 fluid and electrical connectors, and provides a support for the printhead (not shown). The printhead for connection with the printhead support arm 3206 may have a similar shape to the printhead 1208, although it will be appreciated that the connectors on a printhead for connection with the printhead support arm 3206 will be arranged to be complementary to the connectors of the printhead support arm connection interface 3315. In other embodiments, the printhead support arm 3206 may not comprise an elongate strut. The printhead 3208 may be supported by electrical, fluid, and/or mechanical connections between the printhead 3208 and the printhead support arm 3206. The printhead 3208, may in other embodiments be supported by a support component of a printer that is not the printhead support arm.

The elongate strut 3333 comprises a product detection sensor 3305. The product detection sensor is configured to sense the position of an external substrate that moves past the print arm 3204 to be printed on. The product detection sensor 3305 may be of the same type described in relation to FIGS. 6 to 10.

The elongate strut 3333 differs from the elongate struts s 1333 and 2333 of the printhead support arms 1206, 2206 in FIGS. 6 to 10 and 11 respectively, in that the elongate strut 3333 does not comprise guide rails. The omission of guide rails may allow for faster connection of the printhead 3208 with the printhead support arm 3206. It will be appreciated that a printhead comprising guide slots may still be used with the printhead support arm 3206, however the guide slots will be redundant.

Nevertheless, it will be understood that any of the guide rails described in relation to the FIGS. 6 to 10 and FIG. 11 may be applied to the printhead support arm 3206.

FIG. 14 shows a perspective end view of another model of a printhead support arm 4206.

For ease of understanding, only the differences between the printhead support arm 4206 and the printhead support arms 1206, 2206, 3206 will be described.

As with the printhead support arms 1206, 2206, and 3206 the printhead support arm 4206 comprises a plurality of electrical connectors and a plurality of fluid connectors. In particular, the plurality of fluid connectors and the plurality of electrical connectors are provided on a printhead support arm connection interface 4315. The printhead support arm 4206 comprises a high voltage connector 4327 and a low voltage connector 4329. The high voltage connector 4327 and the low voltage connector 4329 may be the same type of connectors as described in relation to FIGS. 6 to 10, FIG. 11, and FIGS. 12 and 13.

The printhead support connection arm interface 4315 further comprises a gutter line connector 4317, a vent line connector 4319, a drive line connector 4321, and a return line connector 4323, which together define fluid connectors. The fluid connectors, 4317, 4319, 4321, and 4323 may be the same type of connectors as those described in relation to FIGS. 6 to 10, FIG. 11, and FIGS. 12 and 13.

The printhead support connection interface 4315 further comprises a mechanical latching barb 4325. The mechanical latching barb 4325 of FIG. 14 is of the same type shown in FIG. 11

The printhead support arm connection interface 4315 also comprises a solenoid 4326. The solenoid 4326 functions in the same manner as the solenoid in FIGS. 6 to 10, FIG. 11, and FIGS. 12 and 13.

The arrangement (layout) of the connectors of the printhead support arm connection interface 4315 differs from the arrangement of the printhead support arm connection interface 1315, 2315, 3315 in FIGS. 6 to 10, FIG. 11, and FIGS. 12 and 13 respectively. In the orientation shown in FIG. 14, the high voltage connector 4327 and the low voltage connector 4329 are provided on a lower region of the interface 4315. Further, the high voltage connector 4327 and the low voltage connector 4329 are provided on a protruding structure 4330 that extends from a face 4328 of the printhead support arm 4206 which the gutter line connector 4317, the vent line connector 4319, the drive line connector 4321, and the return line connector 4323, the latching barb 4325, and the solenoid 4326 extend from. The high voltage connector 4327 and the low voltage connector 4329 are however set back in to a surface of the protruding structure 4330, such that the protruding structure 4330 shelters the high voltage connector 4327 and the low voltage connector 4329. In this way, because the fluid connectors are provided above the electrical connectors (in the orientation shown in FIG. 14), any fluid which may drip from the fluid connectors would drip onto an outer edge 4332 of the protruding structure 4330, and thereby reduce the likelihood of fluid contacting the electrical connectors. This is the orientation that may be required in order to remove the printhead from the printhead support arm 4206. The gutter line connector 4317 and the vent line connector 4319 and disposed between the drive line connector 4321 and the return line connector 4323.

It will be appreciated that a printhead 4208 (not shown) would have corresponding connectors and complementary geometry to engage with the connectors of the printhead support arm 4208.

The printhead support arm 4206 also comprises an elongate strut 4333. The elongate strut 4333 extends in a direction away from the printhead support arm 4206 fluid and electrical connectors and provides a support for the printhead (not shown). The printhead for connection with the printhead support arm 4206 may have a similar shape to the printhead 1208, although it will be appreciated that the connectors on a printhead for connection with the printhead support arm 4206 will be arranged to be complementary to the connectors of the printhead support arm connection interface 4315.

The elongate strut 4333 comprises elongate parallel guide rails 4335 and is identical to the elongate strut 1333 of the printhead support arm 1206 shown in FIG. 6, save as for a product detection sensor is not present. Instead, it can be seen that the elongate strut 4333 defines a recess 4336, for receiving a product detection sensor. The elongate guide rails 4335 allow for a printhead and printhead cover to engage on to the printhead support arm 4206. The recess 4336 comprises a plurality of electrical contacts 4338 for providing at least electrical power to a product detection sensor. Accordingly, the printhead support arm 4206 is configured to receive a removable product detection sensor. In other embodiments, the corresponding printhead may comprise a product detection sensor, and may be configured the receive a removable product detection sensor. Providing a removable product detection sensor is advantageous because during service, maintained and repair only the necessary components need to be accessed or removed and any components (e.g. printhead, product detection sensor) can be readily replaced with like parts. In this way downtime of the printer is reduced, as a printer does not need to be stopped for long periods of time in order to service and replace printhead and other replaceable components.

The printhead of the type described in relation to FIGS. 3 to 14 may be removed from a printhead support arm, and another printhead may be connected to the printhead support arm, and printing operations may resume within around 2 minutes.

When a user is wanting to remove the printhead, they may actuate the push button 1377 (see FIG. 10). Actuation of the push button allows movement of the latch as shown in FIG. 9, and results in disengagement of the latch and latching barb, thus allowing the printhead to be removed and replaced. The push button may act as a release trigger, in doing so a release sequence may be started. The release sequence may include terminating power supply to the printhead.

In embodiments where the latch is electrically locked through use of a solenoid. Actuation of the latch may be prevented until the solenoid is in a retracted position (i.e. electrical unlocking occurs). Moving the solenoid to a retracted position may form part of the release sequence. For example, the printer may comprise a screen or button that allows a user to select when they want to release the printhead, the screen or button may function as a release trigger.

The solenoid may be configured so that it is in a retracted position when an electric current is applied, or it may be configured so that it is in a retracted position when no electric current is applied.

When the solenoid is in a retracted position when an electric current is applied, selection of the release trigger may first cause electrical power supply to components of the printhead to be terminated, and then apply an electric current to the solenoid so that the solenoid moves from an extended position to a retracted position.

When the solenoid is in a retracted position when no electric current is applied, selection of the release trigger may first cause electrical power supply to components of the printhead and to the solenoid to be terminated, so that the solenoid moves from an extended position to a retracted position.

Once the solenoid is in a retracted positon, a user may then remove the printhead by disconnecting the printhead connection interface from the printhead support arm interface.

The printer may comprise a controller, for example the controller 6 shown in FIG. 1 The controller may be arranged to implement a safety protocol, where the controller checks that at least one of the following conditions is satisfied:
There is no transfer of power between the plurality of electrical connectors;
There is no voltage drop across the plurality of electrical connectors;
There is no passage of fluid between the fluid connectors.

The controller may prevent removal of the printhead until one or more predetermined safety conditions are satisfied.

Once the solenoid is in a retracted position, a user may be able to actuate the push button as described above and then remove the printhead. In other embodiments movement of the latch maybe automatically controlled as part of the release sequence, such that the user need only remove the printhead.

Once the printhead is removed, a new printhead may be provided (in some instances, the new printhead may be simply the same printhead that was just removed, having been inspected and/or cleaned). In order to provide the new printhead, a user may simply locate the printhead connection interface with the printhead support arm connection interface. Once the fluid, mechanical and electrical connections are formed, the solenoid if present, may electrically lock the latch. Power may then be supplied to the printhead and printing operations can resume.

FIG. 15 is an exemplary flow chart of the steps that may occur when removing and replacing a printhead, including a release sequence.

For ease of understanding printer components will be provided with the reference numerals used in FIG. 2 and FIGS. 5 to 10. However, it will be appreciated that the below described steps for removing and replacing a printhead are applicable to all embodiments of the invention.

Step 5100 is the first step that is performed which is to shut down the ink jet. That is to say that the printer 1280 stops ejecting ink from the nozzle 134 of the printhead 1208. Shutting down the inkjet may be initiated by a user. For example, a user may engage a release trigger which initiates the release sequence. The release trigger may be a button or switch on the print head 1208 or printer that can be manually actuated, or it may be an interface on a touchscreen. Initiation of the release trigger may cause shut down of the inkjet. However, shut down of the ink jet may be caused, for example if one of the electrical components of the printhead or the printer trips. e.g. if the extra high tension electrical connector 1327 trips. The printer may alert the user if the ink jet is stopped due to a component or electrical failure. As described in further detail below, the step 5100 may include cleaning of the nozzle 134 and the supply line with solvent.

The next step 5200 is to perform safety checks. This may include ensuring that one or more safety conditions are satisfied. The safety checks may be undertaken by a user and a user may be required to confirm via an input mechanism (e.g. switch, touchscreen) that the safety checks have been complete. However, the safety checks may preferably be carried out by a controller 6 of the printer. The safety checks may include but are not limited to, ensuring that EHT is off, and/or stopping power supply, and/or checking the ink pump 130 is off, and/or checking the solvent pump 130 is off, and/or checking the gutter pump 168 is off, and/or checking that a pressure transducer 138 shows a low reading; and/or checking that the fluid valves 126, 142, 144, 146 are closed. Once the safety condition(s) are satisfied the solenoid 1326 may be released. It will be appreciated that performing of the safety checks is optional and is not required in all embodiments.

Step 5300 is disengaging the solenoid 1326. In other words, the solenoid 1326 is moved from an engaged position which prevents movement of the latch 1373, to a disengaged position which allows movement of the latch 1373 and hence the printhead 1208 to be removed. In particular, the solenoid 1326 may move from an extended position to a retracted position. Moving of the solenoid 1326 may be controlled by energising the solenoid (applying a current) or in other embodiments by de-energising the solenoid (removal or absence of a current). The controller 6 of the printer may control movement of the solenoid 1326. As described above, the presence of the solenoid 1326 is not essential in all embodiments. In embodiments which do not comprise a solenoid that functions as an electrical locking mechanism step 5300 may be skipped. Likewise, in other embodiments when electrical locking mechanisms are used other than a solenoid 1326, step 5300 may include unlocking the electrical lock.

Step 5400 is the removal of the printhead 1208. Removal of the printhead is when the printhead 1208 is moved such that the fluid and electrical connectors of the printhead 1208 are not engaged with the corresponding connectors of the printhead support arm 1206. Or, in other embodiments where the fluid and electrical connectors of the printhead 1208 are not engaged with the corresponding connectors on a printer or an umbilical. In some embodiments, in order to remove the printhead 1208 a user may need to disengage a self-coupling locking mechanism (e.g. latch and barb mechanism), by actuating a push button and then pulling the printhead 1208 away from the corresponding connectors. In some embodiments the user may remove the printhead 1208 using a pinch and withdraw mechanism. In some embodiments, wherein the printhead 1208 comprises guide features, the printhead 1208 may have to be moved away from the printhead support member is a single direction, i.e. the printhead 1208 may have to slide away from the corresponding connectors. The steps 5300 and 5400 may take around 10 seconds or less for a user to complete.

Steps 5100, 5200, 5300 and 5400 may define a release sequence 5500. Although it will be appreciated that in some embodiments steps 5200 and 5300 may be omitted. Furthermore, the release sequence 5500 need not be limited to steps 5100, 5200, 5300, 5400.

Following the release sequence 5500. An alternative printhead 1208 can be provided. The alternative printhead 1208 will usually be a different printhead to the printhead 1208 that is removed during the release sequence 5500. Nevertheless, the alternative printhead may be the same printhead 1208 that was removed. For example, a user may remove the printhead 1208, inspect and/or clean the printhead 1208 and then replace it. The step 5600 of providing an alternative printhead includes engaging the printhead connection interface 1339 with the printhead support connection interface 2315, or with a connection interface of an umbilical or printer.

Once an alternative printhead has been provided, the controller 6 of the printer may check that the alternative printhead has been fitted, this is shown as step 5700. In some embodiments the printhead 1208 may comprise a data storage device (for example, an electronic data storage device of the type described in WO 2017194913 A). The controller 6 may be arranged to read the smart chip and authenticate the alternative printhead. In particular, the controller 6 may be able to determine the nozzle size of the printhead 1208, such that printing operations can be adjusted accordingly. The smart chip may be arranged on the printhead 1208 such that it can only be read by the controller 6 once the fluid connectors and electrical connectors of the printhead 1208 are engaged with the corresponding connectors. In some embodiments the smart chip may be arranged so that it can only be read once the self-coupling mechanical interlock 1371 is engaged and/or the electrical locking mechanism (e.g. solenoid 1326 is engaged). The step 5700 is an optional step.

Following, the controller 6 may optionally check if the printhead 1208 is fitted correctly. Shown as step 5800. In some embodiments checking that the alternative printhead 1208 is fitted correctly may be undertaken by a user as an alternative or in addition to the controller 6 checking that the alternative printhead 1208 is fitted correctly. Step 5800 is an optional step, In some embodiments the step 5800 may simply form part of the step 5700.

Once the alternative printhead has been provided, printing operations can commence. Shown as step 5900. Commencing printing operations includes ejecting ink from the nozzle 134 of the printhead 1208. The time taken to provide an alternative printhead (step 5600), check the alternative printhead is fitted (step 5700), check the alternative printhead is fitted correctly (step 5800), and commence printing operations (step 5900), may take around 50 seconds.

The steps 5100, 5200, 5300, 5400, 5500, 5600, 5700, 5800, 5900, may be completed in around 2 minutes.

FIG. 16, is a flow chart showing the steps that may occur within step 5100 of shutting down the inkjet.

The controller 6 may first stop the ink jet 5102.

After stopping the ink jet, the printer, using a pump apply suction to the nozzle 134 of the printhead 1208 to withdraw any ink and/or solvent from the nozzle 134, shown as step 5104. This protects the nozzle 134 from the build-up of ink and/or sediment in the nozzle 134.

The nozzle 134 is then cleaned with solvent 5106. This may comprise supplying solvent from the solvent compartment 110 via solvent supply line 114, and flush line 170, and drawing solvent out of the nozzle 134 via the side port 173 and purge line 172.

The gutter 164 is then cleaned 5108. In particular, the gutter 164 may be cleaned with solvent. The gutter 164 can be cleaned with solvent by jetting solvent through the nozzle 134 of the printhead 1208.

Applying suction to the nozzle 134 (step 5110) then occurs again to remove as much solvent as possible. It is desirable to remove as much solvent as possible to mitigate against blockage.

Suction may also be applied to the return line 166, which may be referred to as a gutter line, at step 5112 so as to remove as much solvent as possible from the gutter 164. It is desirable to remove as much solvent as possible to mitigate against blockage with dried ink.

The pumps 126, 142, 144, 146 may then be shut down in step 5114.

Steps 5112 and 5110 may be completed in the opposite order, or in parallel to what is shown in FIG. 16.

FIG. 17 is a flow chart showing the steps of checking that safety conditions are satisfied in step 5200 of FIG. 15.

The first step 5202 is to check EHT is off. This may be implemented by the controller 6 checking that no power is supplied to the printhead 1208 via the EHT connector 1327.

The next step 5204 is to check that power supply to the electrical components of the printhead 1208 is off (save as for the solenoid in some embodiments).

The next step 5206 is to check that the ink pump 130 is off.

The next step 5208 is to check that the solvent pump is off.

The next step 5210 is to check that the gutter pump 168 is off.

The next step 5212 is to check that the pressure transducer is 138 less than a predetermined pressure. In particular, the pressure may be less than around 0.1 bar.

The next step 5214 is to check that the valves 126, 144, 146, 148 are closed.

In some embodiments the controller 6 may be arranged such that it cannot perform the next safety check until the current check is satisfied. The safety checks shown in FIG. 17 are not limiting, and further safety checks may be implemented. Likewise, not all of the safety checks shown in FIG. 16 are essential and the order of the safety checks may be changed. Further, some or all of the safety checks shown may be conducted in parallel. However, in embodiments where performing safety check 5200 is required, unless the safety checks (5202 to 5214) are satisfied, disengagement of the electrical lock (e.g. solenoid) is prohibited. In some embodiments, the printer may allow a user to manually override some or all of the safety checks.

Although a number of printhead support arms, printheads and printers are described, it will be appreciated that that the printhead support arms, the printheads and printers are not limited to the exact features described and that features of one printhead support arm, printhead, and printer may be combined with another. By way of example, the printhead support arms described are shown as comprising an elongate strut, however, it will be appreciated that the elongate strut is not essential in order for the a printhead of the present invention to connect to a corresponding printhead support arm. In other embodiments, the printhead support arm may not comprise an elongate strut. The printhead may be supported by electrical, fluid, and/or mechanical connections between the printhead and the printhead support arm. The printhead, may in other embodiments be supported by a support component of a printer that is not the printhead support arm. The self-coupling mechanical interlocks of the types described above, may be present without the printhead support arm comprising an elongate strut and/or guide rails.

Likewise, it will be appreciated that the guide rails are not essential in order for the printhead to connect and disconnect with a printhead support arm. In some embodiments, the printhead may connect directly with an umbilical. Whereas in other embodiments, no umbilical may be present.

Various arrangements of fluid and electrical connectors have been described. Again it will be appreciated that any suitable arrangement may be provided, given that correspondingly located and sized connectors are provided on the printhead connection interface and printhead support arm connection interface. Furthermore, the mechanical interlock is not essential to all embodiments of the printhead.

1-2. (canceled)

3. A continuous inkjet printer for printing onto an external substrate that moves past the printer, the printer comprising:
a printhead, the printhead comprising:
a droplet generator configured to generate and eject a stream of ink droplets for printing;
at least one electrode configured to steer the stream of ink droplets; and
a gutter configured to receive droplets of ink which are not used for printing; and
an ink system configured to store ink and supply ink to the printhead;
wherein:
the printhead is releasably connectable to the ink system by a printhead connection interface, the printhead connection interface comprising a plurality of fluid connectors, a plurality of electrical connectors, and cooperating guide features configured to guide the printhead into a connected configuration from a disconnected configuration.

4. The continuous inkjet printer according to claim 3, wherein the printer is configured to permit the printhead to be removed from printer, and for an alternative printhead to be connected to the printer, and for printing operations to commence within a period of around 2 minutes.

5. The continuous inkjet printer according to claim 4, wherein the printer is configured to permit the printhead to be removed from the printer in around 10 seconds or less from one or more safety conditions being satisfied.

6. The continuous inkjet printer according to claim 3, wherein the continuous inkjet printer comprises a controller;
the controller is arranged to check that before the printhead is disconnected there is no current supplied to components of the printhead.

7. The continuous inkjet printer according to claim 3, wherein a first guide feature is provided on the printer and a second guide feature is provided on the printhead.

8. The continuous inkjet printer according to claim 3, wherein the guide features comprise a guide rail or a guide groove.

9. The continuous inkjet printer according to claim 3, further comprising a printhead support for supporting the printhead, wherein the cooperating guide features are configured to allow only generally linear movement of the printhead relative to the printhead support.

10. The continuous inkjet printer according to claim 3, wherein the guide features extend along over 75% a length of the printhead.

11. The continuous inkjet printer according to claim 3, wherein the guide features comprise a first guide region configured to provide coarse guidance and a second guide region configured to provide fine guidance and a tapered region between the first guide region and the second guide region.

12. The continuous inkjet printer according to claim 3, wherein the printhead connection interface comprises a self-coupling mechanical interlock.

13. The continuous inkjet printer according to claim 3, wherein the printhead comprises a removable cover.

14-15. (canceled)

16. A printhead for a continuous inkjet printer, the printhead comprising:
a droplet generator configured to generate and eject a stream of ink droplets for printing;
at least one electrode configured to steer the stream of ink droplets; and
a gutter configured to receive droplets of ink which are not used for printing; and
wherein the printhead is releasably connectable to an ink system of a continuous inkjet system by a printhead connection interface, the printhead connection interface comprising a plurality of electrical connectors, a plurality of fluid connectors, and cooperating guide features configured to guide the printhead into a connected configuration from a disconnected configuration.

17. The printhead according to claim 16, wherein the printhead is configured to be removed from a printer, and for an alternative printhead to be connected to the printer, and for printing operations to commence within a period of around 2 minutes

18. The printhead according to claim 16, wherein the printhead connection interface comprises a self-coupling mechanical interlock.

19. The printhead according to claim 16, wherein the printhead comprises a removable cover and wherein the removable cover is removable from the printhead only when the printhead is not connected to the ink system.

20-21. (canceled)

22. A method of operating a continuous inkjet printer for printing onto an external substrate that moves past the printer, the printer comprising a printhead and an ink system for storing ink and supplying ink to the printhead, wherein the printhead is releasably connectable to the ink system;
the printhead comprising:
a droplet generator configured to generate and eject a stream of ink droplets for printing;
at least one electrode configured to steer the stream of ink droplets; and
a gutter configured to receive droplets of ink which are not used for printing;
wherein the printhead is releasably connectable to the ink system by a printhead connection interface, the printhead connection interface comprising a plurality of fluid connectors, a plurality of electrical connectors, and cooperating guide features configured to guide the printhead into a connected configuration from a disconnected configuration;
the method comprising:
aligning the cooperating guide features;
connecting the plurality of fluid connectors to corresponding connections of the printer; and
connecting the plurality of electrical connectors to corresponding connections of the printer.

23. The method according to claim 22, wherein the method comprises, within a period of around 2 minutes:
removing the printhead from the printer;
providing an alternative printhead;
connecting the plurality of fluid connectors of the alternative printhead to corresponding connections of the printer;
connecting the plurality of electrical connectors of the alternative printhead to corresponding connections of the printer; and
resuming printing operations.

24. The method according to claim 22, wherein
removing the printhead takes place within a period of around 10 seconds or less from one or more safety conditions being satisfied.

25. The method according to claim 22, wherein, prior to removing the printhead, checking no current is supplied to the components of the printhead using a controller and/or,
wherein removing the printhead comprises sliding the printhead away from a printhead support member.

26. The method according to claim 22, wherein providing an alternative printhead comprises sliding the alternative printhead towards a printhead support member.

27-54. (canceled)
